(19) United States
(12) Patent Application Publication
(10) Pub. No.: US 2024/0041079 A1
(43) Pub. Date: Feb. 8, 2024

(54) SWEETENER FORMULATIONS

(71) Applicant: Incredo Ltd., Petach Tikva (IL)

(72) Inventors: David TSIVION, Kfar Shmaryahu (IL); Liron BITAN, Shoham (IL); Naama LAHAV, Hod Hasharon (IL); Alexander TRACHTENBERG, Ramat Gan (IL); Moran FATTAL, Tel Aviv (IL)

(21) Appl. No.: 18/266,593

(22) PCT Filed: Jan. 5, 2022
(86) PCT No.: PCT/IB2022/050065

§ 371 Date: Jun. 12, 2023

Related U.S. Application Data
(60) Provisional application No. 63/133,810, filed on Jan. 5, 2021.

(51) Int. Cl. A23L 27/30; A23L 33/19

(52) U.S. Cl. CPC A23L 27/33; A23L 33/19

(57) ABSTRACT

An edible formulation including: sweetener particles containing at least one of a sweetener carbohydrate and a sweetener polyol, and a milk protein disposed within the sweetener particles, wherein a weight content of the milk protein within the formulation, on a dry basis, is within a range of 0.005% to 1.5%.

### FIELD AND BACKGROUND OF THE INVENTION

The present invention relates to sweet formulations and, more particularly, to edible formulations including one or more proteins disposed in the sweetener particles.

### SUMMARY OF THE INVENTION

According to aspects of the invention there is provided a formulation comprising:
(a) sweetener particles containing a sweetener selected from the group consisting of a sweetener carbohydrate and a sweetener polyol; and
(b) at least one milk protein disposed within said sweetener particles;
   wherein a weight content of said at least one milk protein within the formulation, on a dry basis, is within a range of 0.005% to 1.5%.

According to further aspects of the invention there is provided a formulation comprising:
a) sweetener particles containing a sweetener selected from the group consisting of a sweetener carbohydrate and a sweetener polyol; and
(b) at least one milk protein disposed within said sweetener particles;
   wherein a mucosal adhesion of the formulation is greater than that of a control formulation by 3 to 125%, said control formulation being devoid of said at least one milk protein, but being otherwise identical to the edible formulation.

According to further aspects of the invention there is provided an edible formulation comprising:
(a) the sweetener particles;
(b) at least one milk protein disposed within said sweetener particles;
(c) at least one fat; and
(d) optionally, at least one starch;
   wherein a weight-to-weight ratio of said at least one milk protein to said sweetener within said sweetener particles is within a range of 0.02% to 1.5%;
   and wherein a total concentration of said sweetener, said at least one fat, and said at least one starch, within the edible formulation, is at least 30%, on a weight basis.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only.

In the drawings:

FIG. 1 is a graph plotting the comparative sweetness index of inventive vs. control Petit Beurre Biscuits as a function of calcium caseinate concentration in the sweetener particles;

FIG. 2 is a graph plotting the comparative sweetness index of inventive vs. control Butter Cookies as a function of calcium caseinate concentration in the sweetener particles;

FIG. 3 is a graph plotting the comparative sweetness index of inventive vs. control Hazelnut Spread as a function of calcium caseinate concentration in the sweetener particles; and

FIG. 4 is a graph plotting the comparative sweetness index of inventive vs. control Butter Cookies as a function of whey protein isolate concentration in the sweetener particles.

### DESCRIPTION OF THE PREFERRED EMBODIMENTS

The present disclosure describes improved sweetener formulations and methods for making such improved sweetener formulations and utilizing them in edible products. Such sweetener formulations include one or more species of milk protein that may exhibit any of various mucoadhesive properties.

The inventors have found that the presence of various milk proteins in food may—disadvantageously—reduce the perceived sweetness of the food. Without wishing to be bound by theory, the inventors believe that this may be due, at least in part, to the contribution of such milk proteins to food astringency. Consequently, an additional quantity of sweetener (e.g., sucrose or fructose) may need to be introduced to a food to offset the deleterious influence of the milk protein on food sweetness, food taste, food mouthfeel, etc. This, in turn, may compromise or change various food properties, including textural and baking properties, such that formulation of the food and preparation thereof may require appreciable modification. This phenomenon may be more severe for whey protein isolate relative to whey protein concentrate. This phenomenon may be yet more severe for casein-based proteins relative to the various whey protein formulations. In particular, casein-based proteins may deleteriously impact mouthfeel.

The inventors have further discovered that the location of the milk protein within the food may be of cardinal importance, at least with respect to the sweetness thereof. Specifically, the inventors have discovered when the milk protein is incorporated within the sweetener particles, the milk protein may not negatively impact food sweetness. In fact, the inventors have surprisingly discovered that under certain conditions (e.g., within a particular concentration range of the milk proteins), the presence of such milk proteins within the food may actually enhance food sweetness.

Without wishing to be limited by theory, the inventors believe that mucoadhesion of the milk protein to the mucosa or mucous membranes on the tongue and within the oral cavity may contribute to the retention of sweetener carbohydrates and sweetener polyols, resulting in an enhanced and extended sensation of sweetness. This phenomenon occurs, or is greatly enhanced, when the milk protein is incorporated within the sweetener particles, such that the mucosal adhesion between the mucin-containing mucosa and the milk protein in the sweetener particle helps to fix the sweetener particle to the oral mucosa, or to at least increase the contact time between the sweetener particle to the oral mucosa. This translates into increased activation of the sweetness sensors/receptor sites on the tongue, by way of example.

The inventors have further surprisingly discovered that within a particular, low range of concentrations of milk proteins disposed within the sweetener particles, the increased mucosal adhesion of the milk proteins appears to more than offset various properties of milk proteins that deleteriously affect taste, including perceived sweetness. These deleterious properties include the increased viscosity of the food (inter alfa, reducing the solubility kinetics and hindering the transport of sweetener molecules to the sweetness sensors/receptor sites), covering and blocking oral sweetness sensors/receptor sites, and the non-sweet taste of the milk proteins. By more than offsetting these deleterious properties, the presence of the milk proteins within the sweetener particles may impart appreciably enhanced sweetness to the food.

Examples of such milk proteins exhibiting mucoadhesive activity include, but are not limited to, whey protein and caseins such as calcium caseinate, sodium caseinate, and acid casein.

As used herein in the specification and in the claims section that follows, the term “mucoadhesive agent” and the like refers to a substance exhibiting an affinity for attaching to a mucin layer of a mucosal surface of a human tongue, via mucoadhesion.

As used herein, the term “sweetener carbohydrate” refers to an edible sweetener having at least one carbohydrate moiety, which carbohydrate is processed within the human body to produce energy. This definition is meant to include sweetener carbohydrates having an energy value of at least 0.1 kcal/g, more typically, at least 0.2 kcal/g, more typically, at least 0.5 kcal/g, and yet more typically, at least 1.0 kcal/g. This definition is specifically meant to include allulose.

The term “sweetener carbohydrate” is specifically meant to exclude high-intensity sweeteners such as sucralose, aspartame, and acesulfame-K.

The term “sweetener”, when used alone, is meant to include both sweetener carbohydrates and sweetener polyols.

A sweetener carbohydrate produces a sweet taste when consumed by the typical human consumer. If, on a normalized sweetness scale, on a weight basis, in which sucrose is taken as a standard of 1, maltose is about 0.31, and lactose is about 0.22, the term “sweetener carbohydrate” would apply to lactose, and to any sugar or other nutritive, carbohydrate-containing sweetener having a sweetness within the range of 0.15 to 2.5 on this normalized sweetness scale. Alternatively, it may be stated that the minimum sweetness for the sugar or other nutritive, carbohydrate-containing sweetener would be that of raffinose (which has a sweetness of 0.15 on the above-mentioned scale). More typically, such a sweetener carbohydrate has a sweetness within the range of 0.25 to 2.5, 0.35 to 2.5, 0.45 to 2.5, 0.25 to 1.8, 0.45 to 1.7, 0.15 to 1.7, or 0.35 to 1.5 on this normalized sweetness scale.

It is noted that the relative sweetness of fructose reported in the literature has been reported to be as little as 0.91, and as much as about 1.7. For the avoidance of doubt, the term “sweetener carbohydrate” is meant to include fructose, irrespective of any of its reported relative sweetness values.

As used herein, the term “normalized sweetness scale”, refers to a relative sweetness scale, on a weight basis, in which sucrose is assigned a value of 1.00. More specifically, the normalized sweetness scale is determined according to the methods disclosed in Moscowitz, H. “Ratio Scales of Sugar Sweetness”; Perception & Psychophysics, 1970, Vol. 7 (5), in which the power function for the sugars and polyols/sugar alcohols has an exponent of 1.3 (n=1.3), as disclosed therein in Table 3, and as provided hereinbelow.

From ″Ratio Scales of Sugar
Sweetness″ (Table 3)

| | Percent by | |
|---|---|---|
| | Weight Basis | |
| | | Relative |
| | Rank | Sweetness |
| Sucrose | 1 | 1.00 |
| Fructose | 2 | 0.91 |
| Raftinose | 15 | 0.15 |
| Maltose | 12 | 0.31 |
| Lactose | 14 | 0.22 |
| Dulcitol | 5 | 0.46 |
| Glucose | 4 | 0.45 |
| Galactose | 6 | 0.42 |
| Sorbose | 7 | 0.41 |
| Sorbitol | 9 | 0.37 |
| Mannitol | 11 | 0.33 |
| Arabinose | 8 | 0.39 |
| Rhamnose | 10 | 0.35 |
| Glycerol | 3 | 0.50 |
| Xylose | 13 | 0.26 |

A sweetener carbohydrate may be a monosaccharide or a disaccharide. Examples of sweetener carbohydrates include, but are not limited to, sucrose, glucose, maltose, fructose, lactose, or any combination of sweetener carbohydrates. One or more sweetener carbohydrate may be combined with one or more sweetener polyols. A sweetener carbohydrate may be naturally occurring or synthetically produced.

As used herein, the term “sweetener polyol” refers to a consumable polyol that produces a sweet taste when consumed by the typical human consumer. Non-limiting examples of sweetener polyols include xylitol, maltitol, erythritol, sorbitol, threitol, arabitol, hydrogenated starch hydrolyzates (HSH), isomalt, lactitol, mannitol, or galactitol (dulcitol). In many instances, the polyol is a sugar alcohol. A sugar alcohol can be produced from a carbohydrate by any known method of reduction (via a chemical or biological transformation) of an acid or aldehyde to an alcohol. In other cases, a sweetener polyol can be synthesized from a parent carbohydrate. Alternatively, a sweetener polyol may be obtained from a biological source.

For the avoidance of doubt, the term “sweetener polyol” is meant to include any polyol/sugar alcohol having a sweetness within a range of 0.15 to 2.5 on the above-described normalized sweetness scale. More typically, such a sweetener polyol has a sweetness within a range of 0.15 to 1.5, 0.15 to 1.0, 0.15 to 0.8, 0.15 to 0.7, 0.20 to 0.7, 0.15 to 0.6, or 0.25 to 0.6, on this normalized sweetness scale.

The proteins for use in accordance with the formulations and methods of the present invention may have various mucoadhesive properties.

Mucoadhesion may generally refer to the attachment of particular macromolecules to a mucin layer of a mucosal surface of a human tongue. The mucoadhesive agent's affinity for attaching to a mucin layer of a mucosal surface of a human tongue may be characterized or quantified by various characterization methods.

As used herein in the specification and in the claims section that follows, the terms “mucoadhesion” and “mucosal adhesion” refer to the tendency of a formulation, or of particular macromolecules (e.g., various proteins) to attach to a mucin layer of a mucosal surface of a human tongue.

As used herein in the specification and in the claims section that follows, the term “mucoadhesive agent” and the like refers to a substance exhibiting an affinity for attaching to a mucin layer of a mucosal surface of a human tongue, via mucoadhesion.

The mucoadhesive properties of the proteins for use in accordance with the formulations and methods of the present invention may have numerous hydrophilic groups, such as amine groups, methoxy groups, hydroxyl groups, etc., which may aid the attachment to mucus or cell membranes through various interactions such as hydrogen bonding and electrostatic interactions. Mucoadhesion may be promoted by various physical phenomena, including entanglement.

With respect to whey proteins, by way of example, appreciable electrostatic interactions may occur between positively charged whey proteins (e.g., beta lactoglubolin) and negatively charged saliva proteins.

In some embodiments of the invention, the milk protein includes at least one whey protein.

There are several common types of whey protein, including whey protein concentrate and whey protein isolate. Whey protein concentrate (WPC) contains at least 70% protein and typically contains 70% to 80% protein. WPC additionally contains lactose and fats. Whey protein isolate (WPI) contains at least 90% protein, and may contain lactose and fats, but in smaller quantities than WPC.

In some embodiments, the milk protein includes at least one casein.

In some embodiments, the at least one whey is in the form of a whey concentrate.

In some embodiments, the at least one whey is in the form of a whey protein isolate.

In some embodiments, the at least one whey protein is in the form of whey concentrate and whey protein isolate.

In some embodiments, the milk protein (e.g., whey protein) includes an α-lactalbumin.

In some embodiments, the milk protein (e.g., whey protein) includes a β-lactoglobulin.In some embodiments, the milk protein (e.g., whey protein) includes a serum albumin.

In some embodiments, the milk protein (e.g., whey protein) includes at least one immunoglobulin.

In some embodiments, the at least one casein is a caseinate.

In some embodiments, the at least one casein includes a caseinate.

In some embodiments, the casein is a metal caseinate.

In some embodiments, the caseinate has a form of R⁺¹-caseinate, wherein R has a nominal valence of 1, e.g., potassium caseinate.

In some embodiments, the caseinate has a form of R⁺²-(caseinate)₂, wherein R has a nominal valence of 2, e.g., magnesium caseinate.

In some embodiments, the caseinate has a form of R⁺³-(caseinate)₃, wherein R has a nominal valence of 3, e.g., chromium caseinate.

In some embodiments, the casein is calcium caseinate.

In some embodiments, the casein is selected from the group of caseinates consisting of calcium caseinate, magnesium caseinate, sodium caseinate, potassium caseinate, ammonium caseinate, and chromium caseinate.

In some embodiments, the casein is an acid casein.

In some embodiments, the casein (e.g., calcium caseinate) is in the form of micelles.

Typically, an edible filler material is utilized to make up the reduced amount of sugar in the food formulations of the present invention. Typically, the edible filler may be a dietary fiber or soluble fiber such as a soluble dietary fiber.

In some embodiments, the edible filler may be, or include, a polysaccharide, such as a fructan. Of the fructans, inulin may typically be used.

In some embodiments, the edible filler may be, or include, an oligosaccharide, such as a fructooligosaccharide.

In some embodiments, the soluble fiber may be, or include, resistant maltodextrin, e.g., soluble corn fiber.

In some embodiments, the soluble fiber may be, or include, polydextrose.

In some embodiments, the sweetener is mainly or predominantly sucrose. Typically, at least 90% or at least 95% of the sweetener is sucrose, and more typically, at least 98%, at least 99.5%, or all of the sweetener is sucrose.

The concentration of protein within the sweetener particles is low, typically about 0.5% or less.

Consequently, in the preparation procedures provided below, a highly crystalline sugar product may be produced. Such a sugar product may have a particle size distribution that resembles that of commercially produced table sugar, e.g., having an average particle size (Dv50) of 400 μm.

The solid-liquid separation (filtration) of such a product is facile, and drying may advantageously performed without appreciable agglomeration. Thus—advantageously—no drying agents need be introduced to the sweetener formulations.

If a drying agent were to be added, the concentration would be low, at most 1%, at most 0.5%, or at most 0.1% with respect to the total weight of sweetener and protein within the sweetener particles.

In addition, because the sweetener particle formulation may strongly resemble its sweetener counterpart (i.e., devoid of protein), the specific gravity and bulk density of the sweetener particle formulation may advantageously similar to the specific gravity and bulk density of the pure sweetener counterpart.

The sweetener formulation or edible formulation is typically devoid of silicon-containing species such as silica. In some embodiments, the concentration of silicon within the sweetener formulation or edible formulation is at most 1%, at most 0.5%, at most 0.2%, at most 0.1%, at most 0.05%, at most 0.02%, at most 0.01%, at most 0.005%, or at most 0.003%. Typically, the concentration of silicon within the sweetener formulation or edible formulation is at most 0.002%, at most 0.001%, or the formulation is devoid of silicon.

### EXAMPLES

Reference is now made to the following examples, which together with the above descriptions, illustrate the invention in a non-limiting fashion.

### Equipment

| | | | Measuring | | |
|---|---|---|---|---|---|
| Instruments | Manufacturer | Model | range | Units | Geometry |
| High shear | IKA | IKA T 25 | 3000-25000 | rpm | |
| mixer | | ULTRA- | | | |
| | | TURRAX ® | | | |
| | Silverson | L5M-A | 0-8000 | rpm | |
| Vacuum | Stephan | UMC 5 | 300-3000 | 1/min | |
| mixer-dryer | | | | | |
| (cooking | | | | | |
| mixer) | | | | | |
| Vacuum | Vacuubrand | MZ 2C NT | 50 | Hz | |
| pump | | | | | |
| Laboratory | MRC Ltd | DFO-150 | 25-250 | ° C. | |
| oven | | | | | |
| Ultra | Retsch | ZM200 | 50 | Hz | |
| centrifugal | | | | | |
| mill | | | | | |
| Pocket | ATAGO | PAL-BX/RI | 0.0-93.0 | % | |
| Refracto- | | | | | |
| meter | | | | | |
| Texture | Stable Micro | TA.XTplus | 0-5000 | gram | A/MUC |
| analyzer | Systems | | | | Muco- |
| | | | | | adhesion |
| | | | | | Test Rig |
| Rheometer | Anton Paar | MCR 92 | 0-1000 | 1/s | Bob-cup |
| | GmbH | P/N:159000 | | | cylinder |

### Materials

| Material | Manufacturer | Type/Product Name |
|---|---|---|
| Calcium caseinate | Fonterra | 380 |
| (Ca-Caseinate, CaC) | Cambridge | P0303 |
| | Commodities | |
| | Bulk Nutrients | Ca-caseinate |
| | Friesland campina | Excellion ® Calcium |
| | ingredients | caseinate I |
| Micellar casein | Idapro | MC88 |
| | Agrocomplex | Micellar casein 85 |
| | Milk Specialties | Instant Micellar Casein- |
| | Global | Low Grit Non-GMO |
| Sodium caseinate | Fonterra | 180 |
| (Na-caseinate, NaC) | Friesland campina | Excellion ® Sodium caseinate S |
| | ingredients | |
| | Armor proteins | Extruded sodium caseinates |
| Magnesium caseinate | Friesland campina | Excellion ® Magnesium |
| | ingredients | caseinate S |
| | EPI Ingredients | 880 |
| | Tatua | Magnesium caseinate |
| Potassium caseinate | Agrocomplex | PRO-A0893 |
| | Scott Laboratories | Potassium caseinate |
| | Armor proteins | Spray dried potassium caseinate |
| | Tatua | Potassium caseinate |
| | EPI Ingredients | 710 |
| Ammonium Caseinate | Rose brand products | Ammonium Caseinate |
| | Parchem | Ammonium Caseinate |
| Chromium Caseinate | Parchem | Chromium Caseinate |
| Acid casein | Fonterra | Acid casein |
| | Armor proteins | Acid casein |
| | Milk food | Acid casein |
| Whey protein isolate (WPI) | Fonterra | 8855 |
| | LSP-nutrition | Zero WPI 90 |
| | Myprotein | Impact Whey Isolate |
| Milk protein concentrate | Fonterra | 4861 |
| Whey protein concentrate (WPC) | Fonterra | 322 |
| Inulin | Beneo | Orafti Highly Soluble Inulin |
| | Cosucra | Fibruline |
| | Sensus | Frutafit CLR |

Various common materials (sugars, polyols, etc.) have not been included in this list.

### Example 1: Production of a Protein-Sweetener Dispersion

The protein and carbohydrate sweetener powders are mixed or blended. The resulting powder mixture is added gradually to water. The requisite amount of protein is calculated in ratio to the carbohydrate sweetener (weight-weight). For example: in order to prepare about 1 kilogram (typically 65° Bx) of syrup containing 0.1% protein with respect to the carbohydrate sweetener, 0.65 grams of the protein are mixed with 650 grams of the carbohydrate sweetener. This mixture is added gradually (under constant mixing) to 350 grams of water, typically at room temperature. The mixing vessel is stirred using an overhead stirrer, typically at 50-800 RPM for at least 45 minutes, or for at least 7 minutes using a high shear mixer (up to 10,000 RPM for IKA; up to 5,000 RPM for Silverson), until the protein is fully dispersed.

For proteins that are more difficult to disperse, the water fraction may be pre-heated.

### Example 2: Production of a Protein-Sweetener Dispersion—Full Dispersion

A concentrated sweetener syrup containing one or more carbohydrate sweeteners and/or one or more polyol (typically sugar alcohol) sweeteners, is prepared prior to the addition of the protein, from room temperature to as much as 80° C. in some cases. The default temperature is 60° C. for sucrose and any other di-saccharides, and 70° C. for other sweetener species. The concentration is about 65 wt % for most of the carbohydrate and polyol sweeteners. Some of the lower solubility sweeteners, may require higher water concentrations and/or temperatures in order to fully dissolve. The protein is then added incrementally or instantaneously under constant mixing. Once the protein addition has been completed, the mixing vessel continues to be stirred using an overhead stirrer, typically at 50-800 RPM for at least 45 minutes, or for at least 7 minutes using a high shear mixer (up to 10,000 RPM for IKA; up to 5,000 RPM for Silverson), until the protein is fully dispersed.

When necessary, the syrup is heated to facilitate the dispersion of the protein.

### Example 3: Production of a Protein-Sweetener Dispersion—Full Dispersion

The protein is first dispersed in water. In some cases, the dispersion may be best performed according to the instructions of the manufacturer (e.g., dispersing incrementally in hot water). Once the protein is fully dispersed, the sweetener (carbohydrate or polyol) is gradually introduced under constant mixing, from room temperature to as much as 80° C. in some cases. The default temperature is 60° C. for sucrose and any other di-saccharides, and 70° C. for other sweetener species. Mixing may be effected by means of an overhead stirrer (50-800 RPM for at least 45 minutes) or by means of a high-shear mixer (up to 10,000 RPM for at least 7 minutes when using IKA; up to 5,000 RPM for at least 7 minutes when using the Silverson).

Thus, to prepare about a kilogram of a carbohydrate or polyol sweetener syrup containing about 65% carbohydrate sweetener and 0.1% protein with respect to the carbohydrate sweetener, 0.65 grams of the protein are first dispersed in 350 grams water. Subsequently, 650 grams of the carbohydrate sweetener are added gradually to the protein dispersion to produce the syrup.

### Example 4: Production of a Protein-Sweetener Dispersion—Partial Dispersion

Partial dispersion of the protein may be deliberately effected. A concentrated sweetener syrup (carbohydrate or polyol) is prepared prior to the addition of the protein, as described in Example 2. The protein is then added in instantaneous or substantially instantaneous fashion, without mixing or with gentle mixing, typically up to about 1 minute, so as to deliberately produce small aggregates. In this manner, a concentrated syrup containing partially dispersed protein is produced.

In this “partial dispersion” procedure, it may best to deviate from the dispersion instructions of the protein manufacturer, in order to mitigate the dispersion.

### Example 5: Production of a Dry Powder from the Concentrated Syrup

Concentrated syrup (e.g., produced in any of the above-provided examples) is transferred to the heated double-jacketed vessel of the vacuum dryer (e.g., Stephan). The vessel is heated (typically 60° C.-70° C.), maintained under vacuum (typically 50-300 mbar), and mixed constantly, so as to evaporate the water, typically at a low rate of evaporation, eventually producing a fine dry powder that may be substantially 100% crystalline.

Optionally, the powder may be transferred to an oven operating at 65° C. for further drying for several hours or overnight.

### Example 6: Production of a Protein-Sweetener Dispersion—Minimal Dispersion

A concentrated sweetener syrup (carbohydrate or polyol) is prepared, as described in Example 2. The concentrated syrup (carbohydrate sweetener and water) is transferred to the vacuum mixer-dryer vessel and mixed constantly under vacuum (50-300 mbar) and heating (55° C.-70° C.) so as to evaporate water and further concentrate the syrup. When the syrup is further concentrated to ca. 70-80 wt.%, the vacuum is released, and the protein is added to the concentrated syrup.

The protein is pre-dispersed in a vial. The liquid “dispersant” is typically water, but ethanol or ethanol/water mixtures may also be employed, as necessary, so that the solids are fully suspended. Typically, the protein to liquid ratio in the pre-dispersion is within a range of 1:1 to 1:5. Mixing is performed by manual shaking of the vial. The contents of the vial are then introduced to the concentrated syrup. The heating and vacuum are reapplied, and the syrup is vigorously mixed with the protein as water evaporates, typically at a low rate of evaporation, until a powder is obtained.

Optionally, the powder may be transferred to an oven operating at 65° C. for further drying for several hours or overnight.

### Example 7

A dispersion containing 0.1% calcium caseinate powder (P0303, Cambridge Commodities, 88% protein) was prepared according to Example 2: 0.65 grams of calcium caseinate powder (containing about 0.58 grams protein) were added gradually to a concentrated sucrose syrup containing 650 grams sucrose and 350 grams water. The syrup containing the calcium caseinate was then transferred to the heated double-jacketed vessel of the vacuum dryer, which was heated and maintained under vacuum according to Example 5, to produce a fine dry powder.

### Example 8

A dispersion containing 0.2% calcium caseinate powder was prepared according to Example 2: a concentrated sweetener syrup containing 650 grams sucrose was prepared prior to the addition of the calcium caseinate. 1.3 grams of calcium caseinate powder were then dispersed in the concentrated sweetener syrup. The syrup was transferred to the heated double-jacketed vessel of the vacuum dryer, which was heated and maintained under vacuum according to Example 5, to produce a fine dry powder.

### Example 9

A dispersion containing 0.3% calcium caseinate powder was prepared according to Example 2: a concentrated sweetener syrup containing 650 grams sucrose was prepared prior to the addition of the calcium caseinate. 1.95 grams of calcium caseinate powder were then dispersed in the concentrated sweetener syrup. The syrup was transferred to the heated double-jacketed vessel of the vacuum dryer, which was heated and maintained under vacuum according to Example 5, to produce a fine dry powder.

### Example 10

A dispersion containing 0.5% calcium caseinate powder was prepared according to Example 2: a concentrated sweetener syrup containing 650 grams sucrose was prepared prior to the addition of the calcium caseinate. 3.25 grams of calcium caseinate powder were then dispersed in the concentrated sweetener syrup. The syrup was transferred to the heated double-jacketed vessel of the vacuum dryer, which was heated and maintained under vacuum according to Example 5, to produce a fine dry powder.

### Example 11

A dispersion containing 0.8% calcium caseinate powder was prepared according to Example 2: a concentrated sweetener syrup containing 650 grams sucrose was prepared prior to the addition of the calcium caseinate. 5.2 grams of calcium caseinate powder were then dispersed in the concentrated sweetener syrup. The syrup was transferred to the heated double-jacketed vessel of the vacuum dryer, which was heated and maintained under vacuum according to Example 5, to produce a fine dry powder.

### Example 12

A dispersion containing 1% calcium caseinate powder was prepared according to Example 2: a concentrated sweetener syrup containing 650 grams sucrose was prepared prior to the addition of the calcium caseinate. 6.5 grams of calcium caseinate powder were then dispersed in the concentrated sweetener syrup. The syrup was transferred to the heated double-jacketed vessel of the vacuum dryer, which was heated and maintained under vacuum according to Example 5, to produce a fine dry powder.

### Example 13

A dispersion containing 1.2% calcium caseinate powder was prepared according to Example 2: a concentrated sweetener syrup containing 650 grams sucrose was prepared prior to the addition of the calcium caseinate. 7.8 grams of calcium caseinate powder were then dispersed in the concentrated sweetener syrup. The syrup was transferred to the heated double-jacketed vessel of the vacuum dryer, which was heated and maintained under vacuum according to Example 5, to produce a fine dry powder.

### Example 14

A dispersion containing 1.5% calcium caseinate powder was prepared according to Example 2: a concentrated sweetener syrup containing 650 grams sucrose was prepared prior to the addition of the calcium caseinate. 9.75 grams of calcium caseinate powder were then dispersed in the concentrated sweetener syrup. The syrup was transferred to the heated double-jacketed vessel of the vacuum dryer, which was heated and maintained under vacuum according to Example 5, to produce a fine dry powder.

### Example 15

A dispersion containing 0.02% calcium caseinate powder was prepared according to Example 2: a concentrated sweetener syrup containing 650 grams sucrose was prepared prior to the addition of the calcium caseinate. 0.13 grams of calcium caseinate powder were then dispersed in the concentrated sweetener syrup. The syrup was transferred to the heated double-jacketed vessel of the vacuum dryer, which was heated and maintained under vacuum according to Example 5, to produce a fine dry powder.

### Example 16

A dispersion containing 0.05% calcium caseinate powder was prepared according to Example 2: a concentrated sweetener syrup containing 650 grams sucrose was prepared prior to the addition of the calcium caseinate. 0.325 grams of calcium caseinate powder were then dispersed in the concentrated sweetener syrup. The syrup was transferred to the heated double-jacketed vessel of the vacuum dryer, which was heated and maintained under vacuum according to Example 5, to produce a fine dry powder.

### Examples 17-26

The calcium caseinate formulations of Examples 7 to 16 were prepared, but using fructose instead of sucrose.

### Example 27

A dispersion containing 0.01% sodium caseinate powder (sodium caseinate 180, Fonterra, 92.05% protein) was prepared according to Example 3: 0.065 grams of sodium caseinate powder (containing about 0.060 grams protein) were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 28

A dispersion containing 0.1% sodium caseinate powder was prepared according to Example 3: 0.65 grams of the powder were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 29

A dispersion containing 0.2% sodium caseinate powder was prepared according to Example 3: 1.3 grams of the powder were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 30

A dispersion containing 0.3% sodium caseinate powder was prepared according to Example 3: 1.95 grams of the powder were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 31

A dispersion containing 0.5% sodium caseinate powder was prepared according to Example 3: 3.25 grams of the powder were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 32

A dispersion containing 0.8% sodium caseinate powder was prepared according to Example 3: 5.2 grams of the powder were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 33

A dispersion containing 1.0% sodium caseinate powder was prepared according to Example 3: 6.5 grams of the powder were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 34

A dispersion containing 1.2% sodium caseinate powder was prepared according to Example 3: 7.8 grams of the powder were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 35

A dispersion containing 1.5% sodium caseinate powder was prepared according to Example 3: 9.75 grams of the powder were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 36

A dispersion containing 0.02% sodium caseinate powder was prepared according to Example 3: 0.13 grams of the powder were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 37

A dispersion containing 0.05% sodium caseinate powder was prepared according to Example 3: 0.325 grams of the powder were dispersed in 350 grams water. Subsequently, 650 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Examples 38-47

The sodium caseinate formulations of Examples 26 to 35 were prepared, but using glucose instead of sucrose, and using 550 grams water (instead of 350 grams) in the initial dispersion.

### Example 48

A dispersion containing 0.1% magnesium caseinate powder (Excellion® Magnesium caseinate S) was prepared according to Example 3: 0.65 grams of the powder (containing close to 0.6 grams protein) were dispersed in 350 grams water. Subsequently, 650 grams sucrose were added gradually to the magnesium caseinate dispersion to produce a concentrated syrup. The syrup was transferred to the heated double-jacketed vessel of the vacuum dryer, which was heated and maintained under vacuum according to Example 5, to produce a fine dry powder.

### Example 49

A dispersion containing 0.3% magnesium caseinate powder was prepared according to Example 3: 1.95 grams of the powder were dispersed in 350 grams water. Subsequently, 650 grams sucrose were added gradually to the magnesium caseinate dispersion to produce a concentrated syrup. The syrup was transferred to the heated double jacketed vessel of the vacuum dryer, which was heated and maintained under vacuum according to Example 5, to produce a fine dry powder.

### Example 50

A dispersion containing 0.5% magnesium caseinate powder was prepared according to Example 3: 3.25 grams of the powder were dispersed in 350 grams water. Subsequently, 650 grams sucrose were added gradually to the magnesium caseinate dispersion to produce a concentrated syrup. The syrup was transferred to the heated double jacketed vessel of the vacuum dryer, which was heated and maintained under vacuum according to Example 5, to produce a fine dry powder.

### Example 51

A dispersion containing 1.0% magnesium caseinate powder was prepared according to Example 3: 6.5 grams of the powder were dispersed in 350 grams water. Subsequently, 650 grams sucrose were added gradually to the magnesium caseinate dispersion to produce a concentrated syrup. The syrup was transferred to the heated double-jacketed vessel of the vacuum dryer, which was heated and maintained under vacuum according to Example 5, to produce a fine dry powder.

### Example 52

A dispersion containing 0.1% potassium caseinate powder (PRO-A0893, Agrocomplex, 93% protein) was prepared according to Example 3: 0.65 grams of the potassium caseinate powder (containing close to 0.60 grams protein) were dispersed in 350 grams water. Subsequently, 650 grams sucrose were added gradually to the potassium caseinate dispersion to produce a concentrated syrup. The syrup was transferred to the heated double-jacketed vessel of the vacuum dryer, which was heated and maintained under vacuum according to Example 5, to produce a fine dry powder.

### Example 53

A dispersion containing 0.3% potassium caseinate powder was prepared according to Example 3: 1.95 grams of the powder were dispersed in 350 grams water. Subsequently, 650 grams sucrose were added gradually to the potassium caseinate dispersion to produce a concentrated syrup. The syrup was transferred to the heated double jacketed vessel of the vacuum dryer, which was heated and maintained under vacuum according to Example 5, to produce a fine dry powder.

### Example 54

A dispersion containing 0.5% potassium caseinate powder was prepared according to Example 3: 3.25 grams of the powder were dispersed in 350 grams water. Subsequently, 650 grams sucrose were added gradually to the potassium caseinate dispersion to produce a concentrated syrup. The syrup was transferred to the heated double jacketed vessel of the vacuum dryer, which was heated and maintained under vacuum according to Example 5, to produce a fine dry powder.

### Example 55

A dispersion containing 1.0% potassium caseinate powder was prepared according to Example 3: 6.5 grams of the powder were dispersed in 350 grams water. Subsequently, 650 grams sucrose were added gradually to the potassium caseinate dispersion to produce a concentrated syrup. The syrup was transferred to the heated double-jacketed vessel of the vacuum dryer, which was heated and maintained under vacuum according to Example 5, to produce a fine dry powder.

### Example 56

A dispersion containing 0.1% chromium caseinate powder was prepared according to Example 3: 0.65 grams of the powder were dispersed in 350 grams water. Subsequently, 650 grams sucrose were added gradually to the chromium caseinate dispersion to produce a concentrated syrup. The syrup was transferred to the heated double jacketed vessel of the vacuum dryer, which was heated and maintained under vacuum according to Example 5, to produce a fine dry powder.

### Example 57

A dispersion containing 0.5% chromium caseinate powder was prepared according to Example 3: 3.25 grams of the powder were dispersed in 350 grams water. Subsequently, 650 grams sucrose were added gradually to the chromium caseinate dispersion to produce a concentrated syrup. The syrup was transferred to the heated double jacketed vessel of the vacuum dryer, which was heated and maintained under vacuum according to Example 5, to produce a fine dry powder.

### Example 58

A dispersion containing 1.2% chromium caseinate powder was prepared according to Example 3: 7.8 grams of the powder were dispersed in 350 grams water. Subsequently, 650 grams sucrose were added gradually to the chromium caseinate dispersion to produce a concentrated syrup. The syrup was transferred to the heated double-jacketed vessel of the vacuum dryer, which was heated and maintained under vacuum according to Example 5, to produce a fine dry powder.

### Example 59

A dispersion containing 0.2% mixed caseinate powders was prepared according to Example 3: 0.65 grams of sodium caseinate powder and 0.65 grams of potassium caseinate powder were dispersed in 350 grams water. Subsequently, 650 grams sucrose were added gradually to the mixed caseinate dispersion to produce a concentrated syrup. The syrup was transferred to the heated double-jacketed vessel of the vacuum dryer, which was heated and maintained under vacuum according to Example 5, to produce a fine dry powder.

### Example 60

A dispersion containing 0.2% mixed caseinate powders was prepared according to Example 3: 0.65 grams of calcium caseinate powder and 0.65 grams of magnesium caseinate powder were dispersed in 350 grams water. Subsequently, 650 grams sucrose were added gradually to the mixed caseinate dispersion to produce a concentrated syrup. The syrup was transferred to the heated double-jacketed vessel of the vacuum dryer, which was heated and maintained under vacuum according to Example 5, to produce a fine dry powder.

### Example 61

A dispersion containing 0.02% ammonium caseinate powder was prepared according to Example 3: 0.13 grams of the powder were dispersed in 350 grams water. Subsequently, 650 grams sucrose were added gradually to the ammonium caseinate dispersion to produce a concentrated syrup. The syrup was transferred to the heated double jacketed vessel of the vacuum dryer, which was heated and maintained under vacuum according to Example 5, to produce a fine dry powder.

### Example 62

A dispersion containing 0.1% ammonium caseinate powder was prepared according to Example 3: 0.65 grams of the powder were dispersed in 350 grams water. Subsequently, 650 grams sucrose were added gradually to the ammonium caseinate dispersion to produce a concentrated syrup. The syrup was transferred to the heated double jacketed vessel of the vacuum dryer, which was heated and maintained under vacuum according to Example 5, to produce a fine dry powder.

### Example 63

A dispersion containing 0.5% ammonium caseinate powder was prepared according to Example 3: 3.25 grams of the powder were dispersed in 350 grams water. Subsequently, 650 grams sucrose were added gradually to the ammonium caseinate dispersion to produce a concentrated syrup. The syrup was transferred to the heated double jacketed vessel of the vacuum dryer, which was heated and maintained under vacuum according to Example 5, to produce a fine dry powder.

### Example 64

A dispersion containing 1.0% ammonium caseinate powder was prepared according to Example 3: 6.5 grams of the powder were dispersed in 350 grams water. Subsequently, 650 grams sucrose were added gradually to the ammonium caseinate dispersion to produce a concentrated syrup. The syrup was transferred to the heated double-jacketed vessel of the vacuum dryer, which was heated and maintained under vacuum according to Example 5, to produce a fine dry powder.

### Example 65

A dispersion containing 1.5% ammonium caseinate powder was prepared according to Example 3: 9.75 grams of the powder were dispersed in 350 grams water. Subsequently, 650 grams sucrose were added gradually to the ammonium caseinate dispersion to produce a concentrated syrup. The syrup was transferred to the heated double jacketed vessel of the vacuum dryer, which was heated and maintained under vacuum according to Example 5, to produce a fine dry powder.

### Examples 66-70

The sodium caseinate compositions of Examples 28, 30, 31, 34, and 36 were formulated according to the procedure of Example 2. Each syrup was then transferred to the heated double-jacketed vessel of the vacuum dryer, which was heated and maintained under vacuum according to Example 5, to produce a fine dry powder.

### Examples 71-75

The calcium caseinate compositions of Examples 7, 9, 10, 12, and 15 were formulated according to the procedure of Example 1. Each syrup was then transferred to the heated double-jacketed vessel of the vacuum dryer, which was heated and maintained under vacuum according to Example 5, to produce a fine dry powder.

### Examples 76-77

The sodium caseinate compositions of Examples 27 and 30 were formulated according to the procedure of Example 4. Each syrup was then transferred to the heated double jacketed vessel of the vacuum dryer, which was heated and maintained under vacuum according to Example 5, to produce a fine dry powder.

### Examples 78-82

The calcium caseinate compositions of Examples 7, 9, 10, 12, and 15 were formulated according to the procedure of Example 6.

### Example 83

A dispersion containing 0.05% calcium caseinate powder was prepared according to Example 3: 0.325 grams of calcium caseinate powder were dispersed in 350 grams water. Subsequently, 650 grams maltitol were added gradually to the calcium caseinate dispersion to produce a concentrated syrup. The syrup was transferred to the heated double-jacketed vessel of the vacuum dryer, which was heated and maintained under vacuum according to Example 5, to produce a fine dry powder.

### Example 84

A dispersion containing 0.1% calcium caseinate powder was prepared according to Example 3: 0.65 grams of calcium caseinate powder were dispersed in 350 grams water. Subsequently, 650 grams sorbitol were added gradually to the calcium caseinate dispersion to produce a concentrated syrup. The syrup was transferred to the heated double-jacketed vessel of the vacuum dryer, which was heated and maintained under vacuum according to Example 5, to produce a fine dry powder.

### Example 85

A dispersion containing 0.3% calcium caseinate powder was prepared according to Example 3: 1.95 grams of the powder were dispersed in 350 grams water. Subsequently, 650 grams lactitol were added gradually to the calcium caseinate dispersion to produce a concentrated syrup. The syrup was transferred to the heated double-jacketed vessel of the vacuum dryer, which was heated and maintained under vacuum according to Example 5, to produce a fine dry powder.

### Examples 86-95

The calcium caseinate formulations of Examples 7 to 16 were prepared, but using xylitol instead of sucrose.

### Example 96

A dispersion containing 0.3% sodium caseinate powder was prepared according to Example 3: 1.95 grams of the powder were dispersed in 350 grams water. Subsequently, 650 grams sorbitol were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 97

A dispersion containing 0.3% sodium caseinate powder was prepared according to Example 3: 1.95 grams of the powder were dispersed in 350 grams water. Subsequently, 325 grams sorbitol and 325 grams xylitol were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 98

A dispersion containing 0.3% sodium caseinate powder was prepared according to Example 3: 1.95 grams of the powder were dispersed in 350 grams water. Subsequently, 325 grams sorbitol and 325 grams sucrose were added gradually to the sodium caseinate dispersion to produce a concentrated syrup. The syrup was transferred to the heated double-jacketed vessel of the vacuum dryer, which was heated and maintained under vacuum according to Example 5, to produce a fine dry powder.

### Example 99

A dispersion containing 0.3% calcium caseinate powder was prepared according to Example 3: 1.95 grams of the powder were dispersed in 350 grams water. Subsequently, 550 grams sorbitol and 100 grams sucrose were added gradually to the calcium caseinate dispersion to produce a concentrated syrup. The syrup was transferred to the heated double-jacketed vessel of the vacuum dryer, which was heated and maintained under vacuum according to Example 5, to produce a fine dry powder.

### Example 100

A dispersion containing 0.02% whey protein isolate (WPI) was prepared according to Example 3, using Fonterra™ 8855 (92.58% protein): 0.13 grams of WPI (containing about 0.12 grams protein) were dispersed in 350 grams water. Subsequently, 650 grams sucrose were added gradually to the WPI dispersion to produce a concentrated syrup. The syrup was transferred to the heated double-jacketed vessel of the vacuum dryer, which was heated and maintained under vacuum according to Example 5, to produce a fine dry powder.

### Example 101

A dispersion containing 0.05% WPI was prepared according to Example 3: 0.325 grams of WPI were dispersed in 350 grams water. Subsequently, 650 grams sucrose were added gradually to the WPI dispersion to produce a concentrated syrup. The syrup was transferred to the heated double-jacketed vessel of the vacuum dryer, which was heated and maintained under vacuum according to Example 5, to produce a fine dry powder.

### Example 102

A dispersion containing 0.1% WPI was prepared according to Example 2: 0.65 grams of WPI were added gradually to a concentrated sucrose syrup containing 650 grams sucrose and 350 grams water. The syrup containing the WPI was then transferred to the heated double-jacketed vessel of the vacuum dryer, which was heated and maintained under vacuum according to Example 5, to produce a fine dry powder.

### Example 103

A dispersion containing 0.2% WPI was prepared according to Example 2: a concentrated sweetener syrup containing 650 grams sucrose was prepared prior to the addition of the WPI. 1.3 grams of WPI were then dispersed in the concentrated sweetener syrup. The syrup was transferred to the heated double jacketed vessel of the vacuum dryer, which was heated and maintained under vacuum according to Example 5, to produce a fine dry powder.

### Example 104

A dispersion containing 0.3% WPI was prepared according to Example 3: 1.95 grams of WPI were dispersed in 350 grams water. Subsequently, 650 grams sucrose were added gradually to the WPI dispersion to produce a concentrated syrup. The syrup was transferred to the heated double-jacketed vessel of the vacuum dryer, which was heated and maintained under vacuum according to Example 5, to produce a fine dry powder.

### Example 105

A dispersion containing 0.5% WPI was prepared according to Example 3: 3.25 grams of WPI were dispersed in 350 grams water. Subsequently, 650 grams sucrose were added gradually to the WPI dispersion to produce a concentrated syrup. The syrup was transferred to the heated double-jacketed vessel of the vacuum dryer, which was heated and maintained under vacuum according to Example 5, to produce a fine dry powder.

### Example 106

A dispersion containing 0.8% WPI was prepared according to Example 3: 5.2 grams of WPI were dispersed in 350 grams water. Subsequently, 650 grams sucrose were added gradually to the WPI dispersion to produce a concentrated syrup. The syrup was transferred to the heated double-jacketed vessel of the vacuum dryer, which was heated and maintained under vacuum according to Example 5, to produce a fine dry powder.

### Example 107

A dispersion containing 1.0% WPI was prepared according to Example 3: 6.5 grams of WPI were dispersed in 350 grams water. Subsequently, 650 grams sucrose were added gradually to the WPI dispersion to produce a concentrated syrup. The syrup was transferred to the heated double-jacketed vessel of the vacuum dryer, which was heated and maintained under vacuum according to Example 5, to produce a fine dry powder.

### Example 108

A dispersion containing 1.2% WPI was prepared according to Example 3: 7.8 grams of WPI were dispersed in 350 grams water. Subsequently, 650 grams sucrose were added gradually to the WPI dispersion to produce a concentrated syrup. The syrup was transferred to the heated double-jacketed vessel of the vacuum dryer, which was heated and maintained under vacuum according to Example 5, to produce a fine dry powder.

### Example 109

A dispersion containing 1.5% WPI was prepared according to Example 3: 9.75 grams of WPI were dispersed in 350 grams water. Subsequently, 650 grams sucrose were added gradually to the WPI dispersion to produce a concentrated syrup. The syrup was transferred to the heated double-jacketed vessel of the vacuum dryer, which was heated and maintained under vacuum according to Example 5, to produce a fine dry powder.

### Example 110

A dispersion containing 0.02% whey protein concentrate (WPC) was prepared according to Example 3, using Fonterra™ 322, (79.9% protein): 0.13 grams of WPC (containing about 0.104 grams protein) were dispersed in 350 grams water. Subsequently, 650 grams sucrose were added gradually to the WPC dispersion to produce a concentrated syrup. The syrup was transferred to the heated double-jacketed vessel of the vacuum dryer, which was heated and maintained under vacuum according to Example 5, to produce a fine dry powder.

### Example 111

A dispersion containing 0.05% WPC was prepared according to Example 3: 0.325 grams of WPC were dispersed in 350 grams water. Subsequently, 650 grams sucrose were added gradually to the WPC dispersion to produce a concentrated syrup. The syrup was transferred to the heated double-jacketed vessel of the vacuum dryer, which was heated and maintained under vacuum according to Example 5, to produce a fine dry powder.

### Example 112

A dispersion containing 0.1% WPC was prepared according to Example 2: 0.65 grams of WPC were added gradually to a concentrated sucrose syrup containing 650 grams sucrose and 350 grams water. The syrup containing the WPC was then transferred to the heated double-jacketed vessel of the vacuum dryer, which was heated and maintained under vacuum according to Example 5, to produce a fine dry powder.

### Example 113

A dispersion containing 0.2% WPC was prepared according to Example 2: a concentrated sweetener syrup containing 650 grams sucrose was prepared prior to the addition of the WPC. 1.3 grams of WPC were then dispersed in the concentrated sweetener syrup. The syrup was transferred to the heated double-jacketed vessel of the vacuum dryer, which was heated and maintained under vacuum according to Example 5, to produce a fine dry powder.

### Example 114

A dispersion containing 0.3% WPC was prepared according to Example 3: 1.95 grams of WPC were dispersed in 350 grams water. Subsequently, 650 grams sucrose were added gradually to the WPC dispersion to produce a concentrated syrup. The syrup was transferred to the heated double-jacketed vessel of the vacuum dryer, which was heated and maintained under vacuum according to Example 5, to produce a fine dry powder.

### Example 115

A dispersion containing 0.5% WPC was prepared according to Example 3: 3.25 grams of WPC were dispersed in 350 grams water. Subsequently, 650 grams sucrose were added gradually to the WPC dispersion to produce a concentrated syrup.

The syrup was transferred to the heated double-jacketed vessel of the vacuum dryer, which was heated and maintained under vacuum according to Example 5, to produce a fine dry powder.

### Example 116

A dispersion containing 0.8% WPC was prepared according to Example 3: 5.2 grams of WPC were dispersed in 350 grams water. Subsequently, 650 grams sucrose were added gradually to the WPC dispersion to produce a concentrated syrup. The syrup was transferred to the heated double-jacketed vessel of the vacuum dryer, which was heated and maintained under vacuum according to Example 5, to produce a fine dry powder.

### Example 117

A dispersion containing 1.0% WPC was prepared according to Example 3: 6.5 grams of WPC were dispersed in 350 grams water. Subsequently, 650 grams sucrose were added gradually to the WPC dispersion to produce a concentrated syrup. The syrup was transferred to the heated double-jacketed vessel of the vacuum dryer, which was heated and maintained under vacuum according to Example 5, to produce a fine dry powder.

### Example 118

A dispersion containing 1.2% WPC was prepared according to Example 3: 7.8 grams of WPC were dispersed in 350 grams water. Subsequently, 650 grams sucrose were added gradually to the WPC dispersion to produce a concentrated syrup. The syrup was transferred to the heated double-jacketed vessel of the vacuum dryer, which was heated and maintained under vacuum according to Example 5, to produce a fine dry powder.

### Example 119

A dispersion containing 1.5% WPC was prepared according to Example 3: 9.75 grams of WPC were dispersed in 350 grams water. Subsequently, 650 grams sucrose were added gradually to the WPC dispersion to produce a concentrated syrup. The syrup was transferred to the heated double-jacketed vessel of the vacuum dryer, which was heated and maintained under vacuum according to Example 5, to produce a fine dry powder.

### Examples 120-129

The WPC formulations of Examples 110 to 119 were prepared, but using sorbitol instead of sucrose.

### Examples 130-139

The WPC formulations of Examples 100 to 109 were prepared, but using lactitol instead of sucrose.

### Example 140

A dispersion containing 0.1% denatured WPI was prepared according to the general method articulated in Example 3. 0.65 grams of WPI (Fonterra 8855) were dispersed in 200 grams water. The WPI was mixed for about 4 minutes and was then heated during mixing to 95° C. for 15 minutes to yield the denatured whey protein isolate. Subsequently, 150 grams water were added to the denatured whey protein isolate and 650 grams of sucrose was gradually added to the denatured WPI dispersion to produce a concentrated syrup. The syrup was transferred to the heated double-jacketed vessel of the vacuum dryer, which was heated and maintained under vacuum according to Example 5, to produce a fine dry powder.

### Example 141

A dispersion containing 0.1% acid casein (Fonterra™ acid casein, 88.8% protein) was prepared according to Example 3: 0.65 grams of acid casein were dispersed in 350 grams water. Subsequently, 650 grams sucrose were added gradually to the acid casein dispersion to produce a concentrated syrup. The syrup was transferred to the heated double-jacketed vessel of the vacuum dryer, which was heated and maintained under vacuum according to Example 5, to produce a fine dry powder.

### Example 142

A dispersion containing 0.1% acid casein was prepared according to Example 2, using 650 grams sucrose and 350 grams water. To the concentrated sucrose syrup were added, under constant mixing, 30 mL of phosphoric acid (85%), under constant mixing, yielding a pH of about 3.6. Subsequently, 0.65 grams of acid casein were added gradually to form a dispersion. The syrup was transferred to the heated double-jacketed vessel of the vacuum dryer, which was heated and maintained under vacuum according to Example 5, to produce a fine dry powder.

### Example 143

A dispersion containing 0.1% acid casein was prepared according to Example 2, using 650 grams sucrose and 350 grams water. To the concentrated sucrose syrup were added, under constant mixing, 250 mL of NaOH (1M) to yield a basic concentrated syrup having a pH of 8.52. Subsequently, 0.65 grams of acid casein were added gradually to form a dispersion having a pH of 8.4. The syrup was transferred to the heated double-jacketed vessel of the vacuum dryer, which was heated and maintained under vacuum according to Example 5, to produce a fine dry powder.

### Example 144

A dispersion containing 0.2% acid casein was prepared according to Example 3: 1.3 grams of acid casein were dispersed in 350 grams water. Subsequently, 650 grams sucrose were added gradually to the acid casein dispersion to produce a concentrated syrup. The syrup was transferred to the heated double-jacketed vessel of the vacuum dryer, which was heated and maintained under vacuum according to Example 5, to produce a fine dry powder.

### Example 145

A dispersion containing 0.02% acid casein was prepared according to Example 3: 0.13 grams of acid casein were dispersed in 350 grams water. Subsequently, 650 grams sucrose were added gradually to the acid casein dispersion to produce a concentrated syrup. The syrup was transferred to the heated double-jacketed vessel of the vacuum dryer, which was heated and maintained under vacuum according to Example 5, to produce a fine dry powder.

### Example 146

A dispersion containing 0.05% acid casein was prepared according to Example 3: 0.325 grams of acid casein were dispersed in 350 grams water. Subsequently, 650 grams sucrose were added gradually to the acid casein dispersion to produce a concentrated syrup. The syrup was transferred to the heated double-jacketed vessel of the vacuum dryer, which was heated and maintained under vacuum according to Example 5, to produce a fine dry powder.

### Example 147

A dispersion containing 1.0% acid casein was prepared according to Example 3: 6.5 grams of acid casein were dispersed in 350 grams water. Subsequently, 650 grams sucrose were added gradually to the acid casein dispersion to produce a concentrated syrup. The syrup was transferred to the heated double-jacketed vessel of the vacuum dryer, which was heated and maintained under vacuum according to Example 5, to produce a fine dry powder.

### Example 148

A dispersion containing 0.02% calcium caseinate powder was prepared according to Example 3: 0.13 grams of the powder were dispersed in 350 grams water. Subsequently, 650 grams sucrose were added gradually to the calcium caseinate dispersion to produce a concentrated syrup. The syrup was transferred to the heated double-jacketed vessel of the vacuum dryer, which was heated and maintained under vacuum according to Example 5, to produce a fine dry powder.

### Example 149

A dispersion containing 0.05% calcium caseinate powder was prepared according to Example 3: 0.325 grams of the powder were dispersed in 350 grams water. Subsequently, 650 grams sucrose were added gradually to the calcium caseinate dispersion to produce a concentrated syrup. The syrup was transferred to the heated double jacketed vessel of the vacuum dryer, which was heated and maintained under vacuum according to Example 5, to produce a fine dry powder.

### Example 150

A dispersion containing 0.3% calcium caseinate powder was prepared according to Example 3. 1.95 grams of the powder were dispersed in 350 grams water. Subsequently, 650 grams sucrose were added gradually to the calcium caseinate dispersion to produce a concentrated syrup. The syrup was transferred to the heated double jacketed vessel of the vacuum dryer, which was heated and maintained under vacuum according to Example 5, to produce a fine dry powder.

### Example 151

A dispersion containing 0.5% calcium caseinate powder was prepared according to Example 3. 3.25 grams of the powder were dispersed in 350 grams water. Subsequently, 650 grams sucrose were added gradually to the calcium caseinate dispersion to produce a concentrated syrup. The syrup was transferred to the heated double jacketed vessel of the vacuum dryer, which was heated and maintained under vacuum according to Example 5, to produce a fine dry powder.

### Example 152

A dispersion containing 0.8% calcium caseinate powder was prepared according to Example 3. 5.2 grams of the powder were dispersed in 350 grams water. Subsequently, 650 grams sucrose were added gradually to the calcium caseinate dispersion to produce a concentrated syrup. The syrup was transferred to the heated double-jacketed vessel of the vacuum dryer, which was heated and maintained under vacuum according to Example 5, to produce a fine dry powder.

### Example 153

A dispersion containing 1.0% calcium caseinate powder was prepared according to Example 3 6.5 grams of the powder were dispersed in 350 grams water. Subsequently, 650 grams sucrose were added gradually to the calcium caseinate dispersion to produce a concentrated syrup. The syrup was transferred to the heated double-jacketed vessel of the vacuum dryer, which was heated and maintained under vacuum according to Example 5, to produce a fine dry powder.

### Example 154

A dispersion containing 1.2% calcium caseinate powder was prepared according to Example 3. 7.8 grams of the powder were dispersed in 350 grams water. Subsequently, 650 grams sucrose were added gradually to the calcium caseinate dispersion to produce a concentrated syrup. The syrup was transferred to the heated double-jacketed vessel of the vacuum dryer, which was heated and maintained under vacuum according to Example 5, to produce a fine dry powder.

### Example 155

A dispersion containing 1.5% calcium caseinate powder was prepared according to Example 3: 9.75 grams of the powder were dispersed in 350 grams water. Subsequently, 650 grams sucrose were added gradually to the calcium caseinate dispersion to produce a concentrated syrup. The syrup was transferred to the heated double jacketed vessel of the vacuum dryer, which was heated and maintained under vacuum according to Example 5, to produce a fine dry powder.

### Example 156: Preparation of Petit Beurre Biscuit Samples

Two novel petit beurre biscuit samples having reduced sugar content are prepared, both having 40 wt % less sugar with respect to typical commercially available biscuits. Since the full (non-reduced) sugar petit beurre biscuit batter contains 16.5 wt % sugar, each of the two petit beurre biscuit batters described below is formulated to contain about (100%−40%)·16.5%=9.9 wt % sugar.

The biscuit batters also contain 10.6% palm oil and 59% wheat flour (approximately 40% starch). The biscuit batter also contains about 13% water.

Inulin (about 6.6 wt % of the formulation, on a wet basis) is used as a filler to make up the reduced amount of sugar in both samples (16.5%−9.9%=6.6 wt % inulin). Typically, Orafti Highly Soluble Inulin is utilized.

The second petit beurre batter utilizes a sweetener formulation from various exemplary formulations (described hereinabove) containing a minute amount of protein (e.g., as a mucoadhesive agent). The baked product is referred to as a “Protein Biscuit”. The first petit beurre batter (baked to produce a “Control Biscuit”) is a comparative sample, devoid of the protein in the sweetener formulation. Thus, the recipes are substantially identical except for this minute amount of protein. The preparation process is also identical.

### Example 157: Preparation of Butter Cookie Samples

Three types of butter cookie samples may be prepared. Type I is a “full sugar”, conventional control butter cookie, which may be similar in composition to typical, commercially available butter cookies. Type II is an inventive, reduced-sugar butter cookie containing the inventive protein-containing sweetener. Type III is a reduced sugar control butter cookie, having the identical composition as the Type II inventive, reduced-sugar butter cookie, but being devoid of the protein in the sweetener particles.

The batter for each type of butter cookie contains sugar, 14.6% palm oil, 49.42% wheat flour (containing approximately 40% starch), corn starch (4.2%), water (5.7%), egg (3.6%), soy lecithin (0.19%), baking powder (0.3%), salt (0.2%), 1.2% invert sugar (containing 5% water), 1.5% heavy cream (containing 37% fat and 3.5% lactose), flavor or flavorants (0.1%), with water being the remainder.

The two novel butter cookie samples having reduced sugar (typically sucrose) content are prepared, typically with approximately 40 wt % less sugar with respect to the Type I butter cookie. Since the full sugar (i.e., non-reduced) butter cookie batter contains 19 wt % sugar, each of the two butter cookie batters described below is formulated to contain about (100%−40.45%)·19%=11.3 wt % sugar.

Inulin is used as a filler to make up the reduced amount of sugar in both samples (19%−11.3%=7.7 wt % inulin). Typically, Orafti Highly Soluble Inulin is utilized.

The Type II butter cookie batter, according to the present invention, utilizes a sweetener formulation from various exemplary formulations (described hereinabove) containing a minute amount of protein. The baked product thereof is referred to as a “Protein Cookie”. The Type III, reduced-sugar batter is baked to produce a Type III “Control Cookie”, which is a comparative sample, as described above.

Aside from the formulative differences, the preparation and baking process is identical for the inventive butter cookie and the two types of control butter cookies.

### Example 157A

In many cases, the Type II inventive, reduced-sugar butter cookie may contain reduced sugar in an amount other than the typical reduction of about 40%. By way of (non-exhaustive) example, the Type II butter cookie may contain 50% less sugar, 40% less sugar, 35% less sugar, 20% less sugar, or 10% less sugar. Strictly for comparative purposes, the Type II butter cookie always contains at least 10% less sugar with respect to the Type I “full sugar” control butter cookie.

### Example 158: Preparation of Hazelnut Spread Samples

Two hazelnut spread samples having reduced sugar content are prepared, both having 40 wt % less sugar with respect to typical commercially available hazelnut spreads. Since the full (non-reduced) sugar hazelnut spread contains 49 wt % sugar, each of the two hazelnut spread samples is formulated to contain about (100%−40%)·49%=29.4 wt % sugar.

Inulin (about 19.6 wt % of the formulation) is used as a filler to make up the reduced amount of sugar in both samples (49%−29.4%=19.6 wt % inulin). Typically, Fibruline is utilized.

The other ingredients are hazelnut paste (13%), palm oil (23.7%), cocoa powder, 12% fat (7.4%), and skim milk powder (6.6%).

The second hazelnut spread sample utilizes a sweetener formulation from various exemplary formulations (described hereinabove) containing a minute amount of protein as a mucoadhesive agent., and is referred to as a “Protein Hazelnut Spread”). The first hazelnut spread sample (“Control Hazelnut Spread”) is a comparative sample, devoid of the protein in the sweetener formulation. Thus, the recipes are substantially identical except for this minute amount of protein. The preparation process is also identical.

### Example 159: Taste Evaluation

The exemplary sweetener or edible formulations (e.g., petit beurre biscuits, butter cookies and hazelnut spreads) may be evaluated by trained sensory panelists using a paired-comparison test. The paired-comparison test is a two-product blind test, and the panelists' task is to choose/indicate the sweeter one of the two products (samples). This method is also known as a directional paired-comparison test, with the “directional” component alerting the subject to a specific type of paired test (Sensory Evaluation Practices, 4th Ed., Stone, Bleibaum, Thomas, eds.).

A Comparative Sweetness Index may be calculated from the paired-comparison test results, compiled from all the panelists. For example, if, among 17 panelists, 10 chose the Protein Cookie as being sweeter, while the other 7 panelists chose a comparative Control Cookie, the Comparative Sweetness Index (CSI) would be calculated as:

CSI=(10/17)·100=58.8=59 (rounded)

Broadly speaking, with respect to reduced sugar (Type II) samples, a CSI of 55-60 is considered to be a fair result; a CSI of 60-70 is considered to be a good result; a CSI of 70-80 is considered to be a very good result; and a CSI of 80 or more is considered to be an excellent result.

With respect to “identical” full sugar (Type I) samples, a CSI of 20-25 is considered to be a fair result; a CSI of 25-35 is considered to be a good result; a CSI of 35-45 is considered to be a very good result; and a CSI of 45 or more is considered to be an excellent result.

### Example 159A

Another sensory method used to evaluate samples is difference magnitude estimation (DME). Here, each panelist tastes the two samples, choose the sweetest, and also chooses the difference in sweetness, from the following list:
No difference at all
Extremely small difference
Small difference
Moderate difference
Large difference
Extremely large difference
   Each choice is given a numerical value (0-5), and the average of the panel is calculated (when the first (inventive, protein-containing) sample is indicated as sweeter, the values are taken as positive, and vice versa). Generally, a difference of up to ±1.0 (i.e., within an absolute value of 1), and in some cases, up to ±0.8 or up to ±0.5, is considered to be insignificant (i.e., the sweetness of the samples is substantially the same). An insignificant difference is considered to be a good result for the inventive formulation vs. the control formulation.

### Examples 160-163

The formulations disclosed in Examples 7, 9, 10, and 16 were used to prepare Petit Beurre Biscuits (Protein Biscuits), along with their respective Control Biscuits, according to Example 156.

Pair-comparison test results of the pair-comparison tests, performed and evaluated according to Example 159, are listed below in Table 1.

TABLE 1

| % calcium | |
|---|---|
| caseinate in | Comparative |
| Sweetener | Sweetness |
| Formulation | Index (CSI) |
| 0.05 | 58 |
| 0.1 | 92 |
| 0.3 | 53 |
| 0.5 | 50 |

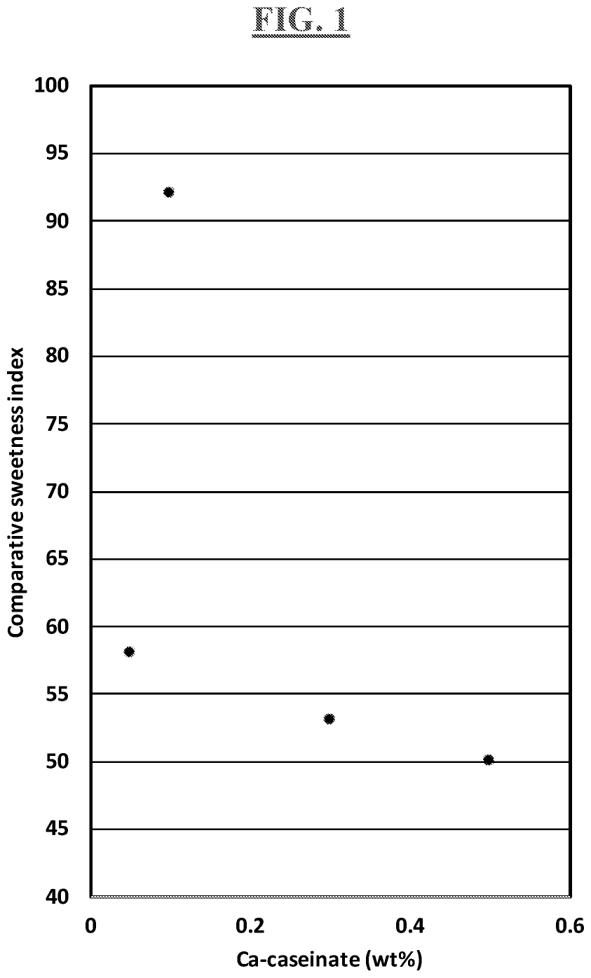

FIG. 1 is a graph plotting the comparative sweetness index for these trials.

### Examples 164-166

The formulations disclosed in Examples 7, 9, and 10 were used to prepare Protein Cookie Samples, along with their respective Type III Control Biscuits, according to Example 157.

Pair-comparison test results of the pair-comparison tests, performed and evaluated according to Example 159, are listed below in Table 2.

TABLE 2

| % calcium | |
|---|---|
| caseinate in | Comparative |
| Sweetener | Sweetness |
| Formulation | Index (CSI) |
| 0.1 | 67 |
| 0.3 | 64 |
| 0.5 | 79 |

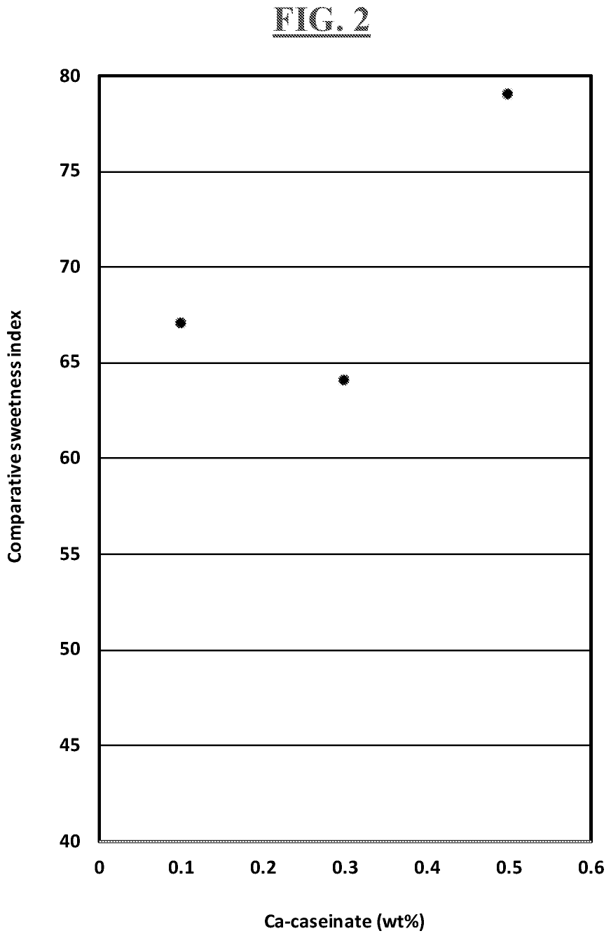

FIG. 2 is a graph plotting the comparative sweetness index for these trials. Over the entire tested range of calcium caseinate concentrations, the inventive sweetener (or edible) formulation (“Protein Cookie”) was found to be sweeter than the Control Cookie, which is devoid of the calcium caseinate within the sugar particles, but is otherwise identical to the biscuit of the present invention.

### Examples 167-169

The formulations disclosed in Examples 7, 9, and 10 were used to prepare Protein Hazelnut Spread Samples, along with their respective Control Hazelnut Spreads, according to Example 158.

Pair-comparison test results of the pair-comparison tests, performed and evaluated according to Example 159, are listed below in Table 3.

TABLE 3

| % calcium | |
|---|---|
| caseinate in | Comparative |
| Sweetener | Sweetness |
| Formulation | Index (CSI) |
| 0.1 | 75 |
| 0.3 | 67 |
| 0.5 | 54 |

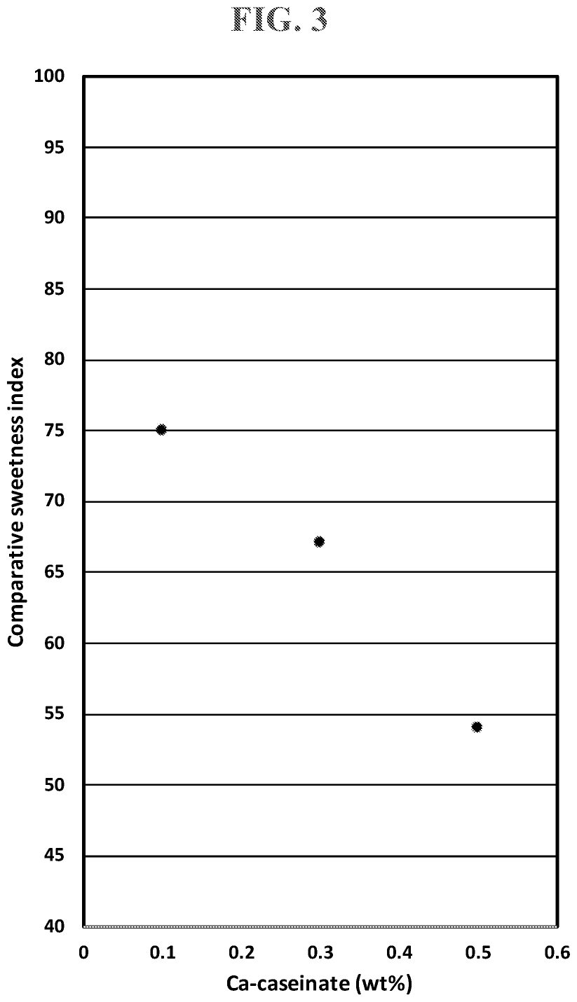

FIG. 3 is a graph plotting the comparative sweetness index for these three trials. Over the entire tested range of calcium caseinate concentrations, the inventive sweetener (or edible) formulation (“Protein Hazelnut Spread”) was found to be sweeter than the Control Hazelnut Spread, which is devoid of the calcium caseinate within the sugar particles.

### Examples 1 70-172

The formulations disclosed in Examples 102, 105, and 107 were used to prepare Protein Cookies, along with their respective Type III Control Biscuits, according to Example 157.

Pair-comparison test results of the pair-comparison tests, performed and evaluated according to Example 159, are listed below in Table 4.

TABLE 4

| % Whey | |
|---|---|
| protein | |
| isolate in | Comparative |
| Sweetener | Sweetness |
| Formulation | Index (CSI) |
| 0.1 | 67 |
| 0.5 | 80 |
| 1 | 73 |

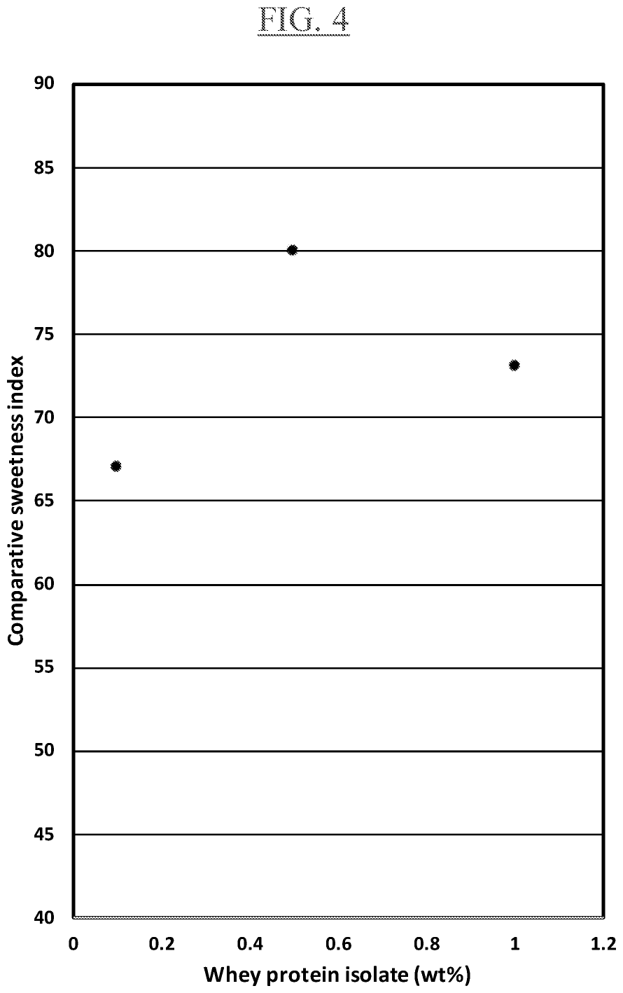

FIG. 4 is a graph plotting the comparative sweetness index for these trials. Over the entire tested range of whey protein isolate concentrations, the inventive sweetener (or edible) formulation (“Protein Cookie”) was found to be sweeter than the Control Cookie, which is devoid of the calcium caseinate within the sugar particles, but is otherwise identical to the biscuit of the present invention.

### Example 173: Exemplary Starch Content Calculation

A cookie is made from fat (palm oil, 17%), white wheat flour (61%), a sugar of the present invention (sucrose, 12%; 0.1% WPI), and a fructan (inulin, 10%). The only starch-containing ingredient is the white wheat flour, which contains about 68% starch. Thus, the starch content of the cookie is 68% of 61%, or about 41.5%.

### Example 174: Exemplary Fat Content Calculation

A hazelnut spread is made from fat (palm oil, 24%), a sugar of the present invention (sucrose, 30%; 0.1% calcium caseinate), pure hazelnut paste (13%, having a 61% fat content), non-fat milk powder (6%), cocoa powder (7% having a 12% fat content) and a fructan (inulin, 20%). The total fat content of the hazelnut spread is 24% +61% of 13% +12% of 7%, or about 32.8%.

### Additional Embodiments

Additional Embodiments (or “Clauses”) 1 to 230 are provided hereinbelow.

Embodiment 1. An edible formulation comprising: (a) sweetener particles containing a sweetener selected from the group consisting of a sweetener carbohydrate and a sweetener polyol; and (b) at least one milk protein disposed within said sweetener particles; wherein a weight-to-weight ratio of said at least one milk protein to said sweetener within said sweetener particles is within a range of 0.02% to 1.5%.
Embodiment 2. An edible formulation comprising: (a) sweetener particles containing a sweetener selected from the group consisting of a sweetener carbohydrate and a sweetener polyol; and (b) at least one milk protein disposed within said sweetener particles; wherein a weight content of said at least one milk protein within the edible formulation, on a dry basis, is within a range of 0.005% to 1.5%.
Embodiment 3. An edible formulation comprising: (a) sweetener particles containing a sweetener selected from the group consisting of a sweetener carbohydrate and a sweetener polyol; and (b) at least one milk protein disposed within said sweetener particles; wherein an average particle size, by weight, of said sweetener particles within the edible formulation is at least 50 μm.
Embodiment 4. An edible formulation comprising: (a) sweetener particles containing a sweetener selected from the group consisting of a sweetener carbohydrate and a sweetener polyol; and (b) at least one milk protein disposed within said sweetener particles; wherein said at least one milk protein is a mucoadhesive agent.
Embodiment 5. An edible formulation comprising: (a) sweetener particles containing a sweetener selected from the group consisting of a sweetener carbohydrate and a sweetener polyol; and (b) at least one milk protein disposed within said sweetener particles; wherein a mucosal adhesion of the edible formulation is greater than that of a control formulation, said control formulation being devoid of said at least one milk protein, but being otherwise identical to the edible formulation.
Embodiment 6. An edible formulation comprising: (a) sweetener particles containing a sweetener selected from the group consisting of a sweetener carbohydrate and a sweetener polyol; and (b) at least one milk protein disposed within said sweetener particles; wherein a mucosal adhesion of the edible formulation is greater than that of a control formulation by at least 10%, and optionally, at least 20%, at least 30%, or at least 50%, said control formulation being devoid of said at least one milk protein, but being otherwise identical to the edible formulation.
Embodiment 7. An edible formulation comprising: (a) sweetener particles containing a sweetener including a sweetener carbohydrate, and optionally, a sweetener polyol; and (b) at least one milk protein disposed within said sweetener particles; wherein a weight-to-weight ratio of said at least one milk protein to said sweetener within said sweetener particles is within a range of 0.02% to 1.5%; and wherein a total concentration of said sweetener and at least one fat within the edible formulation is at least 10%, on a weight basis.
Embodiment 8. An edible formulation comprising: (a) sweetener particles containing a sweetener including a sweetener polyol, and optionally, a sweetener carbohydrate; and (b) at least one milk protein, at least a portion of said at least one milk protein disposed within said sweetener particles; and wherein a total concentration of said sweetener and at least one fat within the edible formulation is at least 10%, on a weight basis.
Embodiment 9. An edible formulation comprising: (a) sweetener particles containing a sweetener including a sweetener carbohydrate, and optionally, a sweetener polyol; and (b) at least one milk protein disposed within said sweetener particles; wherein a weight-to-weight ratio of said at least one milk protein to said sweetener within said sweetener particles is within a range of 0.02% to 1.5%.
Embodiment 10. An edible formulation comprising: (a) sweetener particles containing a sweetener including a sweetener polyol, and optionally, a sweetener carbohydrate; and (b) at least one milk protein disposed within said sweetener particles; wherein a weight-to-weight ratio of said at least one milk protein to said sweetener within said sweetener particles is within a range of 0.02% to 1.5%.
Embodiment 11. An edible formulation comprising: (a) sweetener particles containing a sweetener including a sweetener carbohydrate, and optionally, a sweetener polyol; and (b) at least one milk at least one milk protein disposed within said sweetener particles; wherein a weight-to-weight ratio of said at least one milk protein to said sweetener within said sweetener particles is within a range of 0.02% to 1.5%; and wherein said at least one milk protein is a mucoadhesive agent.
Embodiment 12. An edible formulation comprising: (a) sweetener particles containing a sweetener including a sweetener polyol, and optionally, a sweetener carbohydrate; and (b) at least one milk at least one milk protein disposed within said sweetener particles; wherein a weight-to-weight ratio of said at least one milk protein to said sweetener within said sweetener particles is within a range of 0.02% to 1.5%; and wherein said at least one milk protein is a mucoadhesive agent.
Embodiment 13. An edible formulation comprising: (a) sweetener particles containing a sweetener carbohydrate and optionally containing a sweetener polyol; and (b) at least one milk protein disposed within said sweetener particles; wherein a weight-to-weight ratio of said at least one milk protein to said sweetener within said sweetener particles is within a range of 0.005% to 1.5%; wherein a total weight content of said sweetener polyol, and said sweetener carbohydrate, within the formulation, is at least 10%; wherein an average particle size, by weight, of said sweetener particles within the formulation is at least 50 μm; and wherein said at least one milk protein is a mucoadhesive agent.
Embodiment 14. An edible formulation comprising: (a) sweetener particles containing a sweetener polyol, and optionally containing a sweetener carbohydrate; and (b) at least one milk protein disposed within said sweetener particles; wherein a weight-to-weight ratio of said at least one milk protein to said sweetener within said sweetener particles is within a range of 0.005% to 1.5%; wherein a total weight content of said sweetener polyol, and said sweetener carbohydrate, within the formulation, is at least 10%; wherein an average particle size, by weight, of said sweetener particles within the edible formulation is at least 50 μm; and wherein said at least one milk protein is a mucoadhesive agent.
Embodiment 15. The edible formulation of any one of the preceding embodiments, wherein said at least one milk protein is a casein.
Embodiment 16. The edible formulation of any one of the preceding embodiments, wherein said at least one milk protein includes a casein.
Embodiment 17. The edible formulation of any one of the preceding embodiments, wherein said at least one milk protein is a whey protein.
Embodiment 18. The edible formulation of embodiments 1 to 14 and 16, wherein said at least one milk protein includes a whey protein.
Embodiment 19. An edible formulation comprising: (a) sweetener particles containing a sweetener carbohydrate and optionally containing a sweetener polyol; and (b) at least one milk protein disposed within said sweetener particles; wherein a weight content of said at least one milk protein within the edible formulation, on a dry basis, is within a range of 0.005% to 1.5%, and wherein said milk protein includes a whey protein.
Embodiment 20. An edible formulation comprising: (a) sweetener particles containing a sweetener polyol and optionally containing a sweetener carbohydrate; and (b) at least one milk protein disposed within said sweetener particles; wherein a weight content of said at least one milk protein within the edible formulation, on a dry basis, is within a range of 0.005% to 1.5%, and wherein said milk protein includes a whey protein.
Embodiment 21. An edible formulation comprising: (a) sweetener particles containing a sweetener including a sweetener carbohydrate, and optionally, a sweetener polyol; (b) at least one milk protein disposed within said sweetener particles; (c) at least one fat; and (d) optionally, at least one starch; wherein a weight-to-weight ratio of said at least one milk protein to said sweetener within said sweetener particles is within a range of 0.02% to 1.5%; and wherein a total concentration of said sweetener, said at least one fat, and said at least one starch, within the edible formulation, is at least 30%, on a weight basis.
Embodiment 22. An edible formulation comprising: (a) sweetener particles containing a sweetener carbohydrate and optionally containing a sweetener polyol; and (b) at least one milk protein disposed within said sweetener particles; wherein a weight content of said at least one milk protein within the edible formulation, on a dry basis, is within a range of 0.005% to 1.5%, wherein said milk protein includes a casein.
Embodiment 23. An edible formulation comprising: (a) sweetener particles containing a sweetener polyol and optionally containing a sweetener carbohydrate; and (b) at least one milk protein disposed within said sweetener particles; wherein a weight content of said at least one milk protein within the edible formulation, on a dry basis, is within a range of 0.005% to 1.5%, and wherein said milk protein includes a casein.
Embodiment 24. The edible formulation of embodiment 22 or embodiment 23, wherein said at least one milk protein is a casein.
Embodiment 25. The edible formulation of any one of embodiments 22 to 24, wherein said casein is calcium caseinate.
Embodiment 26. The edible formulation of any one of embodiments 22 to 24, wherein said casein includes calcium caseinate.
Embodiment 27. The edible formulation of any one of embodiments 22 to 24, wherein said casein is sodium caseinate.
Embodiment 28. The edible formulation of any one of embodiments 22 to 24 and embodiment 26, wherein said casein includes sodium caseinate.
Embodiment 29. The edible formulation of any one of embodiments 22 to 24, wherein said casein is magnesium caseinate.
Embodiment 30. The edible formulation of any one of embodiments 22 to 24, embodiment 26, and embodiment 28, wherein said casein includes magnesium caseinate.
Embodiment 31. The edible formulation of any one of embodiments 22 to 24, wherein said casein is potassium caseinate.
Embodiment 32. The edible formulation of any one of embodiments 22 to 24, embodiment 26, embodiment 28, and embodiment 30, wherein said casein includes potassium caseinate.
Embodiment 33. The edible formulation of any one of embodiments 22 to 24, wherein said casein is chromium caseinate.
Embodiment 34. The edible formulation of any one of embodiments 22 to 24, embodiment 26, embodiment 28, embodiment 30 and embodiment 32, wherein said casein includes chromium caseinate.
Embodiment 35. The edible formulation of any one of embodiments 22 to 24, wherein said casein is ammonium caseinate.
Embodiment 36. The edible formulation of any one of embodiments 22 to 24, embodiment 26, embodiment 28, embodiment 30, embodiment 32, and embodiment 34, wherein said casein includes ammonium caseinate.
Embodiment 37. The edible formulation of any one of embodiments 22 to 24, wherein said casein is an acid casein.
Embodiment 38. The edible formulation of any one of embodiments 22 to 24, embodiment 26, embodiment 28, embodiment 30, embodiment 32, embodiment 34 and embodiment 36, wherein said casein includes an acid casein.
Embodiment 39. The edible formulation of any one of the preceding embodiments, wherein said casein is in the form of a micelle.
Embodiment 40. The edible formulation of embodiment 39, wherein said casein includes calcium caseinate.
Embodiment 41. The edible formulation of any one of embodiments 22 to 24 and 39, wherein said casein is a caseinate.
Embodiment 42. The edible formulation of any one of embodiments 22 to 24 and 39, wherein said casein is a metal caseinate.
Embodiment 43. The edible formulation of any one of embodiments 22 to 24 and 39, wherein said casein has a form of R⁺¹-caseinate, wherein R has a nominal valence of 1.
Embodiment 44. The edible formulation of any one of embodiments 22 to 24 and 39, wherein said casein has a form of R⁺²-(caseinate)₂, wherein R has a nominal valence of 2.
Embodiment 45. The edible formulation of any one of embodiments 22 to 24 and 39, wherein said casein has a form of R⁺³-(caseinate)₃, wherein R has a nominal valence of 3.
Embodiment 46. The edible formulation of any one of the preceding embodiments, wherein said at least one milk protein includes a phosphoprotein.
Embodiment 47. The edible formulation of any one of the preceding embodiments, wherein said at least one milk protein is a phosphoprotein.
Embodiment 48. The edible formulation of any one of the preceding embodiments, wherein said at least one milk protein includes a casein phosphoprotein.
Embodiment 49. The edible formulation of any one of the preceding embodiments, wherein said at least one milk protein is a casein phosphoprotein.
Embodiment 50. The edible formulation of any one of the preceding embodiments, wherein said at least one milk protein includes a whey protein.
Embodiment 51. The edible formulation of any one of the preceding embodiments, wherein said at least one milk protein is a whey protein.
Embodiment 52. The edible formulation of any one of the preceding embodiments, wherein said whey protein is in a form of a whey concentrate.
Embodiment 53. The edible formulation of any one of the preceding embodiments, wherein said whey protein is in a form of a whey isolate.
Embodiment 54. The edible formulation of any one of the preceding embodiments, wherein said at least one milk protein includes α-lactalbumin.
Embodiment 55. The edible formulation of any one of the preceding embodiments, wherein said at least one milk protein includes β-lactoglobulin.
Embodiment 56. The edible formulation of any one of the preceding embodiments, wherein said at least one milk protein includes serum albumin.
Embodiment 57. The edible formulation of any one of the preceding embodiments, wherein said at least one milk protein includes an immunoglobulin.
Embodiment 58. The edible formulation of any one of the preceding embodiments, wherein said at least one milk protein includes α-lactalbumin and β-lactoglobulin.
Embodiment 59. The edible formulation of any one of the preceding embodiments, wherein a weight-to-weight ratio of said at least one milk protein to said sweetener within said sweetener particles is within a range of 0.03% to 1.5%.
Embodiment 60. The edible formulation of any one of the preceding embodiments, wherein a weight content of said at least one milk protein within the edible formulation, on a dry basis, is within a range of 0.005% to 1.5%.
Embodiment 61. The edible formulation of any one of the preceding embodiments, wherein an average particle size, by weight, of said sweetener particles within the edible formulation is at least 80 μm.
Embodiment 62. The edible formulation of any one of the preceding embodiments, wherein said at least one milk protein is a mucoadhesive agent.
Embodiment 63. The edible formulation of any one of the preceding embodiments, wherein a or said mucosal adhesion of the edible formulation is greater than that of a control formulation, said control formulation being devoid of said at least one milk protein, but being otherwise identical to the edible formulation.
Embodiment 64. The edible formulation of any one of the preceding embodiments, wherein a or said mucosal adhesion of the edible formulation is greater than that of a control formulation by a value of at least 10%, and optionally, at least 20%, at least 30%, at least 40%, at least 50%, at least 75%, or at least 100%, said control formulation being devoid of said at least one milk protein, but being otherwise identical to the edible formulation.
Embodiment 65. The edible formulation of any one of the preceding embodiments, wherein a or said mucosal adhesion of the edible formulation is greater than that of a control formulation by a value of 5% to 200%, said control formulation being devoid of said at least one milk protein, but being otherwise identical to the edible formulation.
Embodiment 66. The edible formulation of embodiment 65, wherein said mucosal adhesion of the edible formulation is greater than that of said control formulation by a value of 10% to 90%.
Embodiment 67. The edible formulation of embodiment 65, wherein said mucosal adhesion of the edible formulation is greater than that of said control formulation by a value of 15% to 90%.
Embodiment 68. The edible formulation of embodiment 65, wherein said mucosal adhesion of the edible formulation is greater than that of said control formulation by a value of 10% to 70%.
Embodiment 69. The edible formulation of any one of the preceding embodiments, wherein said a value of said mucosal adhesion of the edible formulation is determined by a standard maximum detachment force determination.
Embodiment 70. The edible formulation of any one of the preceding embodiments, wherein a or said mucosal adhesion of the edible formulation is determined by a standard work of detachment determination.
Embodiment 71. The edible formulation of any one of the preceding embodiments, wherein a weight ratio of a total amount of milk proteins in the edible formulation to the amount of said at least one milk protein distributed within said sweetener particles is at most 8.
Embodiment 72. The edible formulation of any one of the preceding embodiments, wherein said at least one milk protein distributed within said sweetener particles is a first particular milk protein, and wherein a weight ratio of a total amount of said first particular milk protein in the edible formulation to the amount of said first particular milk protein distributed within said sweetener particles is at most 4.
Embodiment 73. The edible formulation of any one of the preceding embodiments, wherein an average particle size, by weight, of said sweetener particles within the edible formulation is at least 140 μm.
Embodiment 74. The edible formulation of any one of the preceding embodiments, wherein said at least one milk protein distributed within said sweetener particles is a first particular milk protein, and wherein a weight ratio of a total amount of said first particular milk protein in the edible formulation to the amount of said first particular milk protein distributed within said sweetener particles is at most 2.5.
Embodiment 75. The edible formulation of embodiment 39, wherein said weight ratio of said total amount of said first particular milk protein in the edible formulation to the amount of said first particular milk protein distributed within said sweetener particles is at most 1.5, at most 1.0, or at most 0.5.
Embodiment 76. The edible formulation of any one of the preceding embodiments, wherein a total weight content of said sweetener particles within the edible formulation is at least 5%.
Embodiment 77. The edible formulation of any one of the preceding embodiments, wherein a weight content of said sweetener within the edible formulation is at least 8%.
Embodiment 78. The edible formulation of any one of the preceding embodiments, wherein a weight content of said sweetener within the edible formulation is at least 10%.
Embodiment 79. The edible formulation of any one of the preceding embodiments, wherein a weight content of said sweetener within the edible formulation is at least 15%.
Embodiment 80. The edible formulation of any one of the preceding embodiments, wherein a weight content of said sweetener within the edible formulation is at least 20%.
Embodiment 81. The edible formulation of any one of the preceding embodiments, wherein a weight content of said sweetener within the edible formulation is at least 25%.
Embodiment 82. The edible formulation of any one of the preceding embodiments, wherein a weight content of said sweetener within the edible formulation is at least 30%.
Embodiment 83. The edible formulation of any one of the preceding embodiments, wherein a weight content of said sweetener within the edible formulation is at least 40%.
Embodiment 84. The edible formulation of any one of the preceding embodiments, wherein a weight content of said sweetener within the edible formulation is at least 50%.
Embodiment 85. The edible formulation of any one of the preceding embodiments, wherein a weight content of said sweetener within the edible formulation is at least 65%.
Embodiment 86. The edible formulation of any one of the preceding embodiments, wherein a weight content of said sweetener within the edible formulation is at least 75%.
Embodiment 87. The edible formulation of any one of the preceding embodiments, wherein a weight content of said sweetener within the edible formulation is at least 85%.
Embodiment 88. The edible formulation of any one of the preceding embodiments, wherein a weight content of said sweetener within the edible formulation is at least 90%.
Embodiment 89. The edible formulation of any one of the preceding embodiments, wherein a weight content of said sweetener within the edible formulation is at least 95%.
Embodiment 90. The edible formulation of any one of the preceding embodiments, wherein a total weight content of said sweetener particles within the edible formulation is within a range of 8% to 80%.
Embodiment 91. The edible formulation of embodiment 42, wherein said total weight content of said sweetener particles within the edible formulation is within a range of 10% to 70%.
Embodiment 92. The edible formulation of embodiment 45, wherein said total weight content of said sweetener within the edible formulation is within a range of 15% to 70%.
Embodiment 93. The edible formulation of any one of the preceding embodiments, wherein said sweetener particles have an average particle size (Dv50) of at least 30 μm.
Embodiment 94. The edible formulation of any one of the preceding embodiments, wherein said sweetener particles have an average particle size (Dv50) within a range of 30 μm to 1500 μm.
Embodiment 95. The edible formulation of any one of the preceding embodiments, wherein the edible formulation or said sweetener particles have an average particle size (Dv50) of at least 50 μm.
Embodiment 96. The edible formulation of any one of the preceding embodiments, wherein the edible formulation or said sweetener particles have an average particle size (Dv50) of at least 100 μm.
Embodiment 97. The edible formulation of any one of the preceding embodiments, wherein the edible formulation or said sweetener particles have an average particle size (Dv50) of at least 200 μm.
Embodiment 98. The edible formulation of any one of the preceding embodiments, wherein the edible formulation or said sweetener particles have an average particle size (Dv50) of at least 350 μm.
Embodiment 99. The edible formulation of any one of the preceding embodiments, wherein the edible formulation or said sweetener particles have an average particle size (Dv50) within a range of 100 μm to 1000 μm.
Embodiment 100. The edible formulation of any one of the preceding embodiments, wherein said weight-to-weight ratio is within a range of 0.03% to 1.5%, 0.03% to 1.2%, 0.03% to 1.0%, 0.03% to 0.8%, 0.03% to 0.7%, 0.03% to 0.6%, 0.03% to 0.5%, 0.05% to 1.75%, 0.05% to 1.5%, 0.05% to 1.4%, 0.05% to 1.3%, 0.05% to 1.2%, 0.05% to 1.0%, 0.05% to 0.7%, 0.1% to 1.75%, 0.1% to 1.5%, 0.1% to 1.4%, 0.1% to 1.3%, 0.1% to 1.2%, 0.1% to 1.0%, 0.1% to 0.8%, 0.1% to 0.7%, 0.1% to 0.6%, 0.15% to 1.75%, 0.15% to 1.5%, 0.15% to 1.4%, 0.15% to 1.3%, 0.15% to 1.2%, 0.15% to 1.0%, 0.15% to 0.8%, 0.2% to 1.75%, 0.2% to 1.5%, 0.2% to 1.4%, 0.2% to 1.3%, 0.2% to 1.2%, 0.2% to 1.0%, 0.2% to 0.8%, 0.2% to 0.7%, 0.2% to 0.6%, 0.25% to 1.75%, 0.25% to 1.5%, 0.25% to 1.4%, 0.25% to 1.3%, 0.25% to 1.2%, 0.25% to 1.0%, 0.25% to 0.8%, 0.25% to 0.7%, or 0.25% to 0.6%.
Embodiment 101. The edible formulation of any one of the preceding embodiments, wherein said weight-to-weight ratio of said at least one milk protein to said sweetener within said sweetener particles is within a range of 0.05% to 1.5%.
Embodiment 102. The edible formulation of any one of the preceding embodiments, wherein said weight-to-weight ratio of said at least one milk protein to said sweetener within said sweetener particles is within a range of 0.1% to 1.5%.
Embodiment 103. The edible formulation of any one of the preceding embodiments, wherein said weight-to-weight ratio of said protein to said sweetener within said sweetener particles is within a range of 0.1% to 1.25%.
Embodiment 104. The edible formulation of any one of the preceding embodiments, wherein said weight-to-weight ratio of said at least one milk protein to said sweetener within said sweetener particles is within a range of 0.1% to 1.0%.
Embodiment 105. The edible formulation of any one of the preceding embodiments, wherein said weight-to-weight ratio of said protein to said sweetener within said sweetener particles is within a range of 0.1% to 0.8%.
Embodiment 106. The edible formulation of any one of the preceding embodiments, wherein said weight-to-weight ratio of said at least one milk protein to said sweetener within said sweetener particles is within a range of 0.1% to 0.7%.
Embodiment 107. The edible formulation of any one of the preceding embodiments, wherein said weight content of said protein within the edible formulation, on said dry basis, is at least 0.007%, at least 0.01%, at least 0.025%, at least 0.05%, at least 0.075%, at least 0.1%, at least 0.2%, at least 0.3%, at most 1.5%, at most 1.3%, at most 1.2%, at most 1.1%, at most 1.0%, at most 0.9%, at most 0.8%, at most 0.7%, or at most 0.6%, or within a range of 0.005% to 1.5%, 0.005% to 1.35%, 0.005% to 1.2%, 0.01% to 1.2%, 0.01% to 1.1%, 0.01% to 1.0%, 0.01% to 0.9%, 0.025% to 1.2%, 0.025% to 1.1%, 0.025% to 1.0%, 0.025% to 0.9%, 0.05% to 1.2%, 0.05% to 1.1%, 0.05% to 1.0%, 0.05% to 0.9%, 0.1% to 1.2%, 0.1% to 1.1%, 0.1% to 1.0%, 0.1% to 0.9%, 0.1% to 0.8%, or 0.1% to 0.7%.
Embodiment 108. The edible formulation of any one of the preceding embodiments, wherein said weight content of said at least one milk protein within the edible formulation, on said dry basis, is within a range of 0.005% to 1%.
Embodiment 109. The edible formulation of any one of the preceding embodiments, wherein said weight content of said at least one milk protein within the edible formulation, on said dry basis, is within a range of 0.015% to 0.3%.
Embodiment 110. The edible formulation of any one of the preceding embodiments, wherein said weight content of said at least one milk protein within the edible formulation, on said dry basis, is within a range of 0.015% to 0.1%.
Embodiment 111. The edible formulation of any one of the preceding embodiments, wherein said average particle size, by weight, of said sweetener particles within the edible formulation is at least 60 μm, at least 80 μm, at least 100 μm, at least 120 μm, at least 150 μm; at least 200 μm; at least 220 μm; at least 240 μm, or within a range of 60 μm to 1200 μm, 100 μm to 1200 μm, 120 μm to 1200 μm, 160 μm to 1200 μm, 200 μm to 1200 μm, 240 μm to 1200 μm, 120 μm to 1000 μm, 150 μm to 1000 μm, 180 μm to 1000 μm, 200 μm to 1000 μm, 220 μm to 1000 μm, 240 μm to 1000 μm, 120 μm to 800 μm, 150 μm to 800 μm, 180 μm to 800 μm, 200 μm to 800 μm, 250 μm to 800 μm, or 300 μm to 1200 μm.
Embodiment 112. The edible formulation of any one of the preceding embodiments, wherein said average particle size, by weight, of said sweetener particles within the edible formulation is at least 120 μm.
Embodiment 113. The edible formulation of any one of the preceding embodiments, wherein said average particle size, by weight, of said sweetener particles within the edible formulation is within a range of 150 μm to 1200 μm.
Embodiment 114. The edible formulation of any one of the preceding embodiments, wherein a weight ratio of a total amount of milk proteins in the edible formulation to the amount of said at least one milk protein distributed within said sweetener particles is at most 2.0.
Embodiment 115. The edible formulation of any one of the preceding embodiments, wherein a weight ratio of a total amount of milk proteins in the edible formulation to the amount of said at least one milk protein distributed within said sweetener particles is at most 1.25.
Embodiment 116. The edible formulation of any one of the preceding embodiments, wherein said weight ratio of said total amount of said first particular milk protein in the edible formulation to the amount of said first particular milk protein distributed within said sweetener particles is at most 2.0.
Embodiment 117. The edible formulation of any one of the preceding embodiments, wherein said weight ratio of said total amount of said first particular milk protein in the edible formulation to the amount of said first particular milk protein distributed within said sweetener particles is at most 1.5.
Embodiment 118. The edible formulation of any one of the preceding embodiments, wherein said weight ratio of said total amount of said first particular milk protein in the edible formulation to the amount of said first particular milk protein distributed within said sweetener particles is at most 1.25.
Embodiment 119. The edible formulation of any one of the preceding embodiments, wherein said weight ratio of said total amount of said first particular milk protein in the edible formulation to the amount of said first particular milk protein distributed within said sweetener particles is at most 1.1.
Embodiment 120. The edible formulation of any one of the preceding embodiments, wherein said sweetener carbohydrate is selected from at least one of the group consisting of sucrose, glucose, fructose, maltose, lactose, mannose, allulose, tagatose, xylose, galactose, arabinose, galactofructose.
Embodiment 121. The edible formulation of any one of the preceding embodiments, wherein said sweetener carbohydrate includes sucrose.
Embodiment 122. The edible formulation of any one of the preceding embodiments, wherein said sweetener carbohydrate includes glucose.
Embodiment 123. The edible formulation of any one of the preceding embodiments, wherein said sweetener carbohydrate includes fructose.
Embodiment 124. The edible formulation of any one of the preceding embodiments, wherein said sweetener polyol is a sugar alcohol.
Embodiment 125. The edible formulation of any one of the preceding embodiments, wherein said sweetener polyol is selected from at least one of the group consisting of xylitol, maltitol, erythritol, sorbitol, threitol, arabitol, hydrogenated starch hydrolyzates (HSH), isomalt, lactitol, mannitol, and galactitol (dulcitol).
Embodiment 126. The edible formulation of any one of the preceding embodiments, wherein the formulation is in the form of a particulate solid such as a free-flowing powder.
Embodiment 127. The edible formulation of embodiment 126, wherein said particulate solid is a powder.
Embodiment 128. The edible formulation of any one of the preceding embodiments, wherein a or said mucosal adhesion of the edible formulation is greater than that of a control formulation by a first value of at least 5%, said control formulation being devoid of said at least one milk protein, but being otherwise identical to the edible formulation, said mucosal adhesion of the edible formulation and of the control formulation being determined by a standard work of detachment determination.
Embodiment 129. The edible formulation of embodiment 128, wherein said first value is at most 200%.
Embodiment 130. The edible formulation of embodiment 128, wherein said first value is within a range of 5% to 180%.
Embodiment 131. The edible formulation of embodiment 128, wherein said first value is within a range of 10% to 150%.
Embodiment 132. The edible formulation of embodiment 128, wherein said first value is within a range of 10% to 125%.
Embodiment 133. The edible formulation of embodiment 128, wherein said first value is within a range of 15% to 110%.
Embodiment 134. The edible formulation of embodiment 128, wherein said first value is within a range of 5% to 150%, 5% to 125%, 10% to 100%, 10% to 80%, 15% to 125%, 20% to 180%, 20% to 150%, 20% to 125%, 20% to 100%, 20% to 80%, 30% to 150%, 30% to 125%, 30% to 100%, 30% to 80%, 40% to 150%, 40% to 125%, 40% to 100%, 40% to 80%, 50% to 150%, 50% to 125%, 50% to 100%, or 50% to 90%.
Embodiment 135. The edible formulation of any one of embodiments 128 to 133, wherein said first value is at most 100%, at most 90%, at most 80%, at most 70%, at most 60%, at most 50%, or at most 40%.
Embodiment 136. The edible formulation of any one of the preceding embodiments, wherein a or said mucosal adhesion of the edible formulation is greater than that of a control formulation by a second value of at least 3%, said control formulation being devoid of said at least one milk protein, but being otherwise identical to the edible formulation, said mucosal adhesion of the edible formulation and of the control formulation being determined by a standard maximum detachment force determination.
Embodiment 137. The edible formulation of embodiment 136, wherein said second value is at most 150%.
Embodiment 138. The edible formulation of embodiment 136, wherein said second value is within a range of 3% to 125%.
Embodiment 139. The edible formulation of embodiment 136, wherein said second value is within a range of 5% to 125%.
Embodiment 140. The edible formulation of embodiment 136, wherein said second value is within a range of 5% to 100%.
Embodiment 141. The edible formulation of embodiment 136, wherein said second value is within a range of 5% to 75%.
Embodiment 142. The edible formulation of embodiment 136, wherein said second value is within a range of 5% to 50%.
Embodiment 143. The edible formulation of embodiment 136, wherein said second value is within a range of 5% to 35%.
Embodiment 144. The edible formulation of embodiment 136, wherein said second value is within a range of 7% to 50%.
Embodiment 145. The edible formulation of embodiment 136, wherein said second value is within a range of 7% to 25%.
Embodiment 146. The edible formulation of embodiment 136, wherein said second value is within a range of 10% to 50%.
Embodiment 147. The edible formulation of embodiment 136, wherein said second value is within a range of 3% to 100%, 5% to 60%, 5% to 40%, 7% to 100%, 7% to 80%, 7% to 70%, 7% to 60%, 7% to 40%, 8% to 60%, 8% to 40%, 8% to 30%, 10% to 80%, 10% to 60%, 10% to 35%, or 10% to 30%.
Embodiment 148. The edible formulation of any one of embodiments 136 to 147, wherein said second value is at most 65%, at most 60%, at most 55%, at most 50%, at most 45%, at most 40%, at most 35%, at most 30%, at most 25%, or at most 20%.
Embodiment 149. The edible formulation of any one of the preceding embodiments, wherein a or said mucosal adhesion of the edible formulation is greater than that of a control formulation by a first value of at least 5%, said control formulation being devoid of said at least one milk protein, but being otherwise identical to the edible formulation, said first value being determined by a standard work of detachment determination; and wherein a or said mucosal adhesion of the edible formulation is greater than that of said control formulation by a second value of at least 3%, said second value being determined by a standard maximum detachment force determination.
Embodiment 150. The edible formulation of embodiment 149, wherein said first value is within a range of 5% to 150%, and wherein said second value is within a range of 3% to 75%.
Embodiment 151. The edible formulation of embodiment 149, wherein said first value is within a range of 10% to 125%, and wherein said second value is within a range of 5% to 50%.
Embodiment 152. An edible formulation comprising: (a) sweetener particles containing at least one sweetener selected from the group consisting of a sweetener carbohydrate and a sweetener polyol; (b) at least one milk protein disposed within said sweetener particles; (c) at least one fat; (d) optionally, at least one starch; and (e) optionally, at least one edible filler; wherein a weight-to-weight ratio of said at least one milk protein to said sweetener within said sweetener particles is within a range of 0.02% to 1.5%; and wherein a total concentration of said sweetener, said at least fat, and said at least one starch, within the edible formulation, is at least 30%, on a weight basis.
Embodiment 153. The edible formulation of any one of the preceding embodiments, the edible formulation further comprising an or said edible filler.
Embodiment 154. The edible formulation of any one of the preceding embodiments, wherein a concentration of an or said edible filler within the edible formulation is at least 3%.
Embodiment 155. The edible formulation of embodiment 154, wherein said concentration of said edible filler is at least 5%.
Embodiment 156. The edible formulation of embodiment 154, wherein said concentration of said edible filler is at least 7%.
Embodiment 157. The edible formulation of embodiment 154, wherein said concentration of said edible filler is at least 10%.
Embodiment 158. The edible formulation of embodiment 154, wherein said concentration of said edible filler is at least 12%.
Embodiment 159. The edible formulation of embodiment 154, wherein said concentration of said edible filler is at least 15%.
Embodiment 160. The edible formulation of embodiment 154, wherein said concentration of said edible filler is within a range of 3% to 35%.
Embodiment 161. The edible formulation of embodiment 154, wherein said concentration of said edible filler is within a range of 3% to 30%.
Embodiment 162. The edible formulation of embodiment 154, wherein said concentration of said edible filler is within a range of 5% to 30%.
Embodiment 163. The edible formulation of embodiment 154, wherein said concentration of said edible filler is within a range of 7% to 25%.
Embodiment 164. The edible formulation of embodiment 154, wherein said concentration of said edible filler is within a range of 10% to 35%.
Embodiment 165. The edible formulation of embodiment 154, wherein said concentration of said edible filler is within a range of 10% to 25%.
Embodiment 166. The edible formulation of embodiment 154, wherein said concentration of said edible filler is within a range of 12% to 25%.
Embodiment 167. The edible formulation of embodiment 154, wherein said concentration of said edible filler is within a range of 15% to 25%.
Embodiment 168. The edible formulation of any one of the preceding embodiments, wherein an or said edible filler within the edible formulation is a soluble fiber.
Embodiment 169. The edible formulation of any one of the preceding embodiments, wherein an or said edible filler within the edible formulation is a dietary fiber.
Embodiment 169. The edible formulation of embodiment 168, wherein said dietary fiber is a soluble dietary fiber.
Embodiment 170. The edible formulation of any one of the preceding embodiments, wherein an or said edible filler within the edible formulation is, or includes, a polysaccharide.
Embodiment 171. The edible formulation of embodiment 170, wherein said polysaccharide is, or includes, a fructan.
Embodiment 172. The edible formulation of embodiment 171, wherein said fructan is inulin.
Embodiment 173. The edible formulation of embodiment 171, wherein said fructan includes inulin.
Embodiment 174. The edible formulation of any one of the preceding embodiments, wherein an or said edible filler within the edible formulation is, or includes, an oligosaccharide.
Embodiment 175. The edible formulation of embodiment 174, wherein said oligosaccharide is, or includes, a fructooligosaccharide.
Embodiment 176. The edible formulation of any one of the preceding embodiments, wherein an or said soluble fiber within the edible formulation is, or includes, a resistant maltodextrin.
Embodiment 177. The edible formulation of any one of the preceding embodiments, wherein an or said soluble fiber within the edible formulation is, or includes, soluble corn fiber.
Embodiment 178. The edible formulation of any one of the preceding embodiments, wherein an or said soluble fiber within the edible formulation is, or includes, polydextrose.
Embodiment 179. The edible formulation of any one of the preceding embodiments, wherein a total concentration of said sweetener and an or said at least one fat is at least 10%, on a weight basis.
Embodiment 180. The edible formulation of embodiment 179, wherein said total concentration of said sweetener and said at least one fat is at least 15%, on said weight basis.
Embodiment 181. The edible formulation of embodiment 179, wherein said total concentration of said sweetener and said at least one fat is at least 20%, on said weight basis.
Embodiment 182. The edible formulation of embodiment 179, wherein said total concentration of said sweetener and said at least one fat is at least 25%, on said weight basis.
Embodiment 183. The edible formulation of embodiment 179, wherein said total concentration of said sweetener and said at least one fat is at least 30%, on said weight basis.
Embodiment 184. The edible formulation of embodiment 179, wherein said total concentration of said sweetener and said at least one fat is at least 40%, on said weight basis.
Embodiment 185. The edible formulation of any one of the preceding embodiments, wherein a total concentration of said sweetener, an or said at least one fat, and a or said at least one starch within the edible formulation is at least 32%, on a weight basis.
Embodiment 186. The edible formulation of embodiment 185, wherein said total concentration of said sweetener, said at least one fat, and said at least one starch within the edible formulation is at least 35%, on said weight basis.
Embodiment 187. The edible formulation of embodiment 185, wherein said total concentration of said sweetener, said at least one fat, and said at least one starch within the edible formulation is at least 40%, on said weight basis.
Embodiment 188. The edible formulation of embodiment 185, wherein said total concentration of said sweetener, said at least one fat, and said at least one starch within the edible formulation is at least 45%, on said weight basis.
Embodiment 189. The edible formulation of embodiment 185, wherein said total concentration of said sweetener, said at least one fat, and said at least one starch within the edible formulation is at least 50%, on said weight basis.
Embodiment 190. The edible formulation of embodiment 185, wherein said total concentration of said sweetener, said at least one fat, and said at least one starch within the edible formulation is at least 55%, on said weight basis.
Embodiment 191. The edible formulation of embodiment 185, wherein said total concentration of said sweetener, said at least one fat, and said at least one starch within the edible formulation is at least 60%, on said weight basis.
Embodiment 192. The edible formulation of any one of the preceding embodiments, wherein a total concentration of said sweetener, an or said at least one fat, a or said at least one starch, and a or said edible filler within the edible formulation is at least 50%, on a weight basis.
Embodiment 193. The edible formulation of embodiment 192, wherein said total concentration of said sweetener, said at least one fat, said at least one starch, and said edible filler within the edible formulation is at least 55%.
Embodiment 194. The edible formulation of embodiment 192, wherein said total concentration of said sweetener, said at least one fat, said at least one starch, and said edible filler within the edible formulation is at least 60%.
Embodiment 195. The edible formulation of embodiment 192, wherein said total concentration of said sweetener, said at least one fat, said at least one starch, and said edible filler within the edible formulation is at least 65%.
Embodiment 196. The edible formulation of embodiment 192, wherein said total concentration of said sweetener, said at least one fat, said at least one starch, and said edible filler within the edible formulation is at least 70%.
Embodiment 197. The edible formulation of embodiment 192, wherein said total concentration of said sweetener, said at least one fat, said at least one starch, and said edible filler within the edible formulation is at least 75%.
Embodiment 198. The edible formulation of any one of the preceding embodiments, wherein a concentration of cocoa powder within the edible formulation is at least 2%.
Embodiment 199. The edible formulation of embodiment 198, wherein said concentration of cocoa powder is at least 3%.
Embodiment 200. The edible formulation of embodiment 198, wherein said concentration of cocoa powder is at least 5%.
Embodiment 201. The edible formulation of any one of the preceding embodiments, containing at least 5% of said sweetener, at least 5% of a or said at least one fat, and at least 5% of a or said at least one starch.
Embodiment 202. The edible formulation of embodiment 201, containing at least 2% of a or said edible filler.
Embodiment 203. The edible formulation of embodiment 201 or embodiment 202, containing at least 10% of said sweetener, at least 10% of a or said at least one fat, and at least 10% of a or said at least one starch.
Embodiment 204. The edible formulation of embodiment 201, containing at least 5% of a or said edible filler.
Embodiment 205. The edible formulation of embodiment 201, containing at least 8% of a or said edible filler.
Embodiment 206. The edible formulation of any one of the preceding embodiments, wherein said sweetener predominantly includes said sweetener carbohydrate.
Embodiment 207. The edible formulation of any one of the preceding embodiments, wherein said sweetener carbohydrate mainly includes sucrose.
Embodiment 208. The edible formulation of any one of the preceding embodiments, wherein said sweetener carbohydrate predominantly includes sucrose, or includes at least 90%, at least 95%, at least 97%, or at least 99% sucrose.
Embodiment 209. The edible formulation of any one of the preceding embodiments, wherein said sweetener particles are non-aerated.
Embodiment 210. The edible formulation of any one of the preceding embodiments, wherein said sweetener carbohydrate is a crystalline sweetener carbohydrate.
Embodiment 211. The edible formulation of any one of the preceding embodiments, wherein said sweetener carbohydrate has a crystalline structure.
Embodiment 212. The edible formulation of any one of the preceding embodiments, wherein said sweetener particles have a sweetener specific gravity that is within 3% of the crystalline reference specific gravity of said sweetener.
Embodiment 213. The edible formulation of embodiment 212, wherein said sweetener specific gravity is within 2.5, 2.0, 1.5, or 1.0% of the crystalline reference specific gravity.
Embodiment 214. The edible formulation of any one of the preceding embodiments, wherein said sweetener mainly includes sucrose, and wherein a or said sweetener specific gravity of said sweetener particles is at least 1540, 1550, 1560, 1570, or 1580 kg/m³,
Embodiment 215. The edible formulation of embodiment 214, wherein said sweetener specific gravity of said sweetener particles is at least 1550 kg/m³.
Embodiment 216. The edible formulation of embodiment 215, wherein said sweetener specific gravity of said sweetener particles is within a range of 1550 to 1590 kg/m³.
Embodiment 217. The edible formulation of any one of the preceding embodiments, wherein said sweetener particles have a sweetener bulk density that is within 8, 7, 6, or 5% of the crystalline reference bulk density of said sweetener.
Embodiment 218. The edible formulation of embodiment 217, wherein said sweetener bulk density is within 5% of the crystalline reference bulk density.
Embodiment 219. The edible formulation of any one of the preceding embodiments, wherein said sweetener is sucrose, and wherein a or said sweetener bulk density of said sweetener particles is at least 750, 775, 800, 825, or 850 kg/m³.
Embodiment 220. The edible formulation of embodiment 219, wherein said sweetener bulk density is at least 775 kg/m³,
Embodiment 221. The edible formulation of embodiment 219, wherein said sweetener bulk density is within a range of 750 to 900 kg/m³.
Embodiment 222. The edible formulation of any one of the preceding embodiments, wherein a first total concentration of said sweetener and said at least one milk protein within said sweetener particles, on a dry basis, is within a range of 80 to 100%, 90 to 100%, 95 to 100%, 97 to 100%, 97.5 to 100%, 98 to 100%, 98.5 to 100%, 99 to 100%, 99.2 to 100%, 99.4 to 100%, 99.6 to 100%, or 99.8 to 100%.
Embodiment 223. The edible formulation of embodiment 222, wherein said first total concentration is within a range of 97.5 to 100%.
Embodiment 224. The edible formulation of embodiment 222, wherein said first total concentration is within a range of 98.5 to 100%.
Embodiment 225. The edible formulation of embodiment 222, wherein said first total concentration is within a range of 99 to 100%.
Embodiment 226. The edible formulation of any one of the preceding embodiments, wherein said sweetener is mainly sucrose, an average particle size (Dv50) of the edible formulation or said sweetener particles is within a range of 100 μm to 1000 μm, said sucrose has a crystalline structure or is a crystalline sweetener carbohydrate,
Embodiment 227. The edible formulation of embodiment 226, wherein a or said mucosal adhesion of the edible formulation exceeds that of a control formulation by 5% to 200%, said control formulation being devoid of said at least one milk protein, but being otherwise identical to the edible formulation.
Embodiment 228. The edible formulation of embodiment 226 or 227, wherein said sweetener particles have a sweetener bulk density that is within 5% of the crystalline reference bulk density of said sweetener.
Embodiment 229. The edible formulation of any one of embodiments 226 to 228, wherein said sweetener particles have a sweetener specific gravity that is within 3% of the crystalline reference specific gravity of said sweetener.
Embodiment 230. The edible formulation of any one of the preceding embodiments, wherein said sweetener is sucrose.

As used herein in the specification and in the claims section that follows, the term “milk protein” is meant to include a native protein typically found in the milk of at least one mammal, and most typically, in the milk of at least one of cows, goats and sheep. The term “milk protein” is also meant to include non-native milk proteins, including a denatured protein of said native protein, or, a modified protein of said native protein, as will be appreciated by those of skill in the art. An example of a non-native milk protein is calcium caseinate.

For the avoidance of doubt, it is emphasized that the term “denatured protein” (or “denatured milk protein” and the like) does not include disruption to the primary protein structure, such as disruption to the sequence of amino acids held together by covalent peptide bonds.

As used herein in the specification and in the claims section that follows, the term “starch” is meant to include edible starches that are used or may be used in foodstuffs. Typically, such starches include at least one of amylose and amylopectin, and more typically, both amylose and amylopectin. It will be appreciated that various modifications of starch may be made, in order to impart to a particular foodstuff, or to the starch therein, specific chemical and/or physical properties, including, by way of example, the prevention of gelling at cold temperatures, withstanding low pH, or resistance to high shear or to high temperatures.

Often, starch is present in an ingredient, e.g., flour. In white wheat flour, the starch content is typically about 68%. In oats, the starch content is typically about 58%.

In addition to including fats that are solid at room temperature (25° C.), e.g., beef fat, shortening, palm oil, and butter, as used herein in the specification and in the claims section that follows, the term “fat” is meant to include edible oils, including those that are liquid at room temperature, e.g., cooking oils. Specific examples of edible oils are olive oil, walnut oil, corn oil, and cottonseed oil.

Fats may be a separate ingredient, or may be an ingredient within a food ingredient. For example, hazelnut paste and cocoa powder both contain fat.

As used herein in the specification and in the claims section that follows, the term “crystalline structure”, with respect to a sweetener, refers to a sweetener whose morphology is at least 80%, at least 90%, or at least 95% crystalline, or is essentially 100%. These percentages may be according to particle weight (or volume), or by particle number, and may be determined by measurement methods known to those of skill in the art.

As used herein in the specification and in the claims section that follows, the term “crystalline sweetener” (e.g., “crystalline sweetener carbohydrate”, “crystalline sweetener polyol”) refers to a sweetener whose sweetener particles, when subjected to X-ray diffraction analysis (XRD), exhibit a diffraction pattern that is indicative of the crystalline nature of the sweetener.

Average particle size (D50) may be based on the number of particles in the population (“D_{N}50”) or may be based on the volume of particles (Dv50). These measurements may be obtained by various known methods including static light scattering (SLS), dynamic light scattering (DLS), sieving, and various methods of microscopy. Some methods may be preferred for larger ranges of particles, others may be preferred for smaller ranges of particles. As used herein in the specification and in the claims section that follows, the term “percent”, or “%”, refers to percent by weight, unless specifically indicated otherwise. However, with specific regard to formulations containing at least one protein and at least one sweetener, the weight-percent of the protein is with respect to the sweetener. By way of example, in such a formulation containing 1.95 grams calcium caseinate dispersed in a syrup containing 650 grams sucrose and 350 grams water, the weight-percent of calcium caseinate is 1.95/650=0.3%.

As used herein in the specification and in the claims section that follows, the term “crystalline reference” with respect to a specific gravity or to a bulk density of a sweetener substance, refers to the specific gravity or to the bulk density of the sweetener substance, when the sweetener substance has a purely crystalline morphology.

For sucrose, the crystalline reference specific gravity is 1589 kg/m³, and the crystalline reference bulk density is 900 kg/m³.

As used herein in the specification and in the claims section that follows, the term “concentration” refers to concentration on a weight basis, unless specifically indicated otherwise.

As used herein in the specification and in the claims section that follows, the term “mainly includes”, with respect to a component within a formulation, refers to a weight content of at least 50%.

As used herein in the specification and in the claims section that follows, the term “predominantly includes”, with respect to a component within a formulation, refers to a weight content of at least 65%.

The term “ratio”, as used herein in the specification and in the claims section that follows, refers to a weight ratio, unless specifically indicated otherwise.

The modifier “about” and “substantially” used in connection with a quantity is inclusive of the stated value and has the meaning dictated by the context (for example, it includes at least the degree of error associated with the measurement of the particular quantity). When used with a specific value, it should also be considered as disclosing that value.

In the context of the present application and claims, the phrase “at least one of A and B” is equivalent to an inclusive “or”, and includes any one of “only A”, “only B”, or “A and B”. Similarly, the phrase “at least one of A, B, and C” is equivalent to an inclusive “or”, and includes any one of “only A”, “only B”, “only C”, “A and B”, “A and C”, “B and C”, or “A and B and C”.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An edible formulation comprising:
(a) sweetener particles containing a sweetener selected from the group consisting of a sweetener carbohydrate and a sweetener polyol; and
(b) at least one milk protein disposed within said sweetener particles;
wherein a weight content of said at least one milk protein within the edible formulation, on a dry basis, is within a range of 0.005% to 1.5%.

2. The edible formulation of claim 1, wherein a mucosal adhesion of the edible formulation exceeds that of a control formulation by 5% to 200%, said control formulation being devoid of said at least one milk protein, but being otherwise identical to the edible formulation.

3. The edible formulation of claim 1, wherein a mucosal adhesion of the edible formulation exceeds that of a control formulation by 3% to 125%, said control formulation being devoid of said at least one milk protein, but being otherwise identical to the edible formulation.

4. The edible formulation of claim 2 or claim 3, wherein said mucosal adhesion exceeds that of said control formulation by 10% to 90%.

5. The edible formulation of any one of claims 2 to 4, wherein said mucosal adhesion exceeds that of said control formulation by at most 50%.

6. The edible formulation of any one of claims 2 to 5, wherein said mucosal adhesion is determined by a standard maximum detachment force determination.

7. The edible formulation of any one of claims 2 to 5, wherein said mucosal adhesion of the edible formulation is determined by a standard work of detachment determination.

8. The edible formulation of any one of the preceding claims, wherein an average particle size (Dv50) of the edible formulation or said sweetener particles is within a range of 100 μm to 1000 μm.

9. The edible formulation of any one of the preceding claims, wherein an average particle size (Dv50) of the edible formulation or said sweetener particles is at least 150 μm.

10. The edible formulation of any one of the preceding claims, wherein said sweetener predominantly includes said sweetener carbohydrate.

11. The edible formulation of any one of the preceding claims, wherein said sweetener carbohydrate is a crystalline sweetener carbohydrate.

12. The edible formulation of any one of the preceding claims, wherein said sweetener carbohydrate has a crystalline structure.

13. The edible formulation of any one of the preceding claims, wherein a first total concentration of said sweetener and said at least one milk protein within said sweetener particles, on said dry basis, is within a range 97 to 100%.

14. The edible formulation of claim 13, wherein said first total concentration is within a range 98.5 to 100%.

15. The edible formulation of any one of the preceding claims, wherein said sweetener particles have a sweetener specific gravity that is within 3% of the crystalline reference specific gravity of said sweetener.

16. The edible formulation of any one of the preceding claims, wherein said sweetener carbohydrate mainly includes sucrose.

17. The edible formulation of claim 16, wherein the bulk density of the sweetener particles is within a range of 750 to 900 kg/m³.

18. An edible formulation comprising:
(a) the sweetener particles of any one of claims 1 to 17;
(b) at least one fat;
(c) optionally, at least one starch; and
(d) optionally, at least one edible filler;
wherein a weight-to-weight ratio of said at least one milk protein to said sweetener within the sweetener particles is within a range of 0.02% to 1.5%;
and wherein a total concentration of said sweetener, said at least fat, and said at least one starch, within the edible formulation, is at least 30%, on a dry weight basis.

19. The edible formulation of any one of the preceding claims, wherein a weight content of said sweetener within the edible formulation is at least 10%, and a concentration of said edible filler is within a range of 3% to 35%.

20. The edible formulation of any one of the preceding claims, containing at least 5% of said sweetener, at least 5% of a or said at least one fat, and at least 5% of a or said at least one starch.
